(19) United States
(12) Patent Application Publication
(10) Pub. No.: US 2026/0106942 A1
(43) Pub. Date: Apr. 16, 2026

(54) SERVICE PROVIDING SERVER, CONTROL METHOD, AND SYSTEM

(71) Applicant: CANON KABUSHIKI KAISHA, Tokyo (JP)

(72) Inventor: YUSUKE KOBANA, Kanagawa (JP)

(21) Appl. No.: 19/350,974

(22) Filed: Oct. 6, 2025

(30) Foreign Application Priority Data
Oct. 16, 2024 (JP) 2024-180617

(51) Int. Cl. H04N 1/00; H04N 1/21; H04N 1/44

(52) U.S. Cl. CPC H04N 1/00244; H04N 1/00344; H04N 1/2166; H04N 1/4426; H04N 2201/0094

(57) ABSTRACT

A service providing server that provides a print service and a scan service registers an image processing apparatus as a printing apparatus or a scanner apparatus based on a request to register the image processing apparatus from the image processing apparatus; manages storage destination information of an external storage service that is a storage destination of scanned image data; receives the scanned image data from the image processing apparatus registered as the scanner apparatus; and transmits, to the external storage service, a request to store the scanned image data to the storage destination indicated by the storage destination information by using an access token for using the external storage service, the access token being acquired in accordance with user authentication on a client terminal for an authentication service.

### BACKGROUND

### Field of the Technology

The present disclosure relates to a technique for a service providing server that provides a scan service and a print service.

### Description of the Related Art

A mode in which an image processing apparatus is instructed to scan a document and transmit a scanned image to a specific destination is referred to as “push scanning”. Examples of the destination include various cloud storage servers.

In recent years, an instruction to perform push scanning is not limited to an instruction from an operation on a screen of the image processing apparatus, and may be an instruction from a client terminal connected to the image processing apparatus via a network (for example, PCT Japanese Translation Patent Publication No. 2013-543339).

However, it has been necessary to consider an improvement in the convenience of cloud scanning in which such a scanned image as described above is uploaded to cloud storage.

### SUMMARY

According to an aspect of the present disclosure, there is provided a system including an image processing apparatus, an information processing terminal, and an intermediate server. The information processing terminal includes a setting unit that sets scan settings as settings for a scan job, information serving as transmission destination settings for scanned image data and identifying a storage server as a transmission destination, and storage destination information and authentication information of the storage server. The intermediate server includes a first registration unit that registers the scan job for which the scan settings and the transmission destination settings have been set, a first transmission unit that transmits, to the image processing apparatus, the scan job in accordance with a request from the image processing apparatus, and a second transmission unit that receives, from the image processing apparatus, the scanned image data read by the image processing apparatus based on the scan settings, and transmits, to the storage server, the scanned image data in accordance with the transmission destination settings. The image processing apparatus includes a first acquisition unit that acquires the scan job from the intermediate server, and a controller that transmits, to the intermediate server, the scanned image data obtained by the scanning performed based on the scan settings for the scan job.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a configuration of a system including an image processing apparatus according to an embodiment.

FIG. 2 is a diagram illustrating a hardware configuration of an MFP.

FIG. 3 is a diagram illustrating an example of a hardware configuration of a client terminal.

FIG. 4 is a diagram illustrating an example of a hardware configuration of an intermediate server.

FIG. 5 is a diagram illustrating an example of a hardware configuration of a storage server.

FIG. 6 is a diagram illustrating an example of a sequence for registration of the MFP in the intermediate server according to one or more aspects of the present disclosure.

FIG. 7 is a diagram illustrating an example of a sequence for push scanning according to one or more aspects of the present disclosure.

FIG. 8 is a diagram illustrating an example of a scanner selection screen of the client terminal according to one or more aspects of the present disclosure.

FIG. 9 is a diagram illustrating an example of a transmission settings screen of the client terminal according to one or more aspects of the present disclosure.

FIG. 10 is a diagram illustrating an example of a storage destination folder selection screen of the client terminal according to one or more aspects of the present disclosure.

FIG. 11 is a diagram illustrating an example of a scan settings screen of the client terminal according to one or more aspects of the present disclosure.

FIG. 12 is a diagram illustrating an example of a push scanning completion screen of the client terminal according to one or more aspects of the present disclosure.

FIG. 13 is a flowchart illustrating an example of a process from acquisition of a scanner list to completion of transmission of a scanned image by the client terminal according to one or more aspects of the present disclosure.

FIG. 14 is a flowchart illustrating an example of a transmission destination setting process by the client terminal according to one or more aspects of the present disclosure.

FIG. 15 is a flowchart illustrating an example of a scan setting process by the client terminal according to one or more aspects of the present disclosure.

FIG. 16 is a flowchart of scan job registration by the client terminal according to one or more aspects of the present disclosure.

FIG. 17 is a flowchart illustrating an example of a process by the MFP according to one or more aspects of the present disclosure.

FIG. 18 is a flowchart illustrating an example of a process by the intermediate server according to one or more aspects of the present disclosure.

FIG. 19 is a flowchart illustrating an example of a process by the storage server according to one or more aspects of the present disclosure.

FIG. 20 is a diagram illustrating an example of a sequence for registration of the MFP in the intermediate server according to one or more aspects of the present disclosure.

FIG. 21 is a diagram illustrating an example of a sequence for push scanning according to one or more aspects of the present disclosure.

FIG. 22 is a flowchart illustrating an example of a process from acquisition of a scanner list to completion of transmission of a scanned image by the client terminal according to one or more aspects of the present disclosure.

FIG. 23 is a flowchart illustrating an example of a transmission process by the client terminal according to one or more aspects of the present disclosure.

FIG. 24 is a flowchart illustrating an example of a process by the MFP according to one or more aspects of the present disclosure.

FIG. 25 is a flowchart illustrating an example of a process by the intermediate server according to one or more aspects of the present disclosure.

### DESCRIPTION OF THE EMBODIMENTS

Hereinafter, embodiments of the present disclosure will be described. The following embodiments do not limit the claims, and not all of combinations of features described in the embodiments are necessarily essential for the solution of the present disclosure.

### First Embodiment

A first embodiment of the present disclosure describes a configuration in which an image processing apparatus acquires a push scan job from an intermediate server and transmits a scanned image to destination cloud storage via the intermediate server.

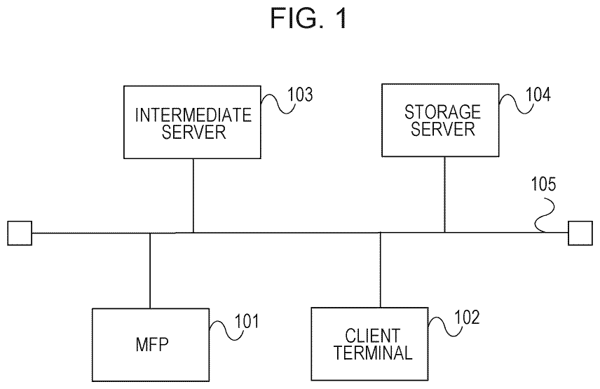

First, a system according to an embodiment of the present disclosure will be described with reference to FIG. 1.

FIG. 1 is a diagram illustrating an example of a configuration of the system including an image processing apparatus according to the embodiment of the present disclosure.

In the system according to the present embodiment, a multi-function peripheral (MFP) 101, a client terminal 102, an intermediate server 103, and a storage server 104 are communicably connected to each other via a network line 105.

The MFP 101 is, for example, a full-color image processing apparatus that uses an electrophotographic method. The MFP 101 has a scan function, a copy function, and a print function. The printing method of the MFP 101 is not limited to the electrophotographic method, and may be another printing method such as an ink-jet method.

The MFP 101 has a function of acquiring a scan job from the intermediate server 103 via the network line 105 and transmitting an electronic file including image data acquired by scanning a document with a scanner included in the MFP 101 in accordance with the scan job. This transmission function includes transmission via the intermediate server 103. The MFP 101 has a function of setting settings for cooperation with the intermediate server 103. Instead of the MFP 101, a scanning apparatus (scanner apparatus or image reader) that does not have a print function may be used as the image processing apparatus.

The client terminal 102 is a general information processing terminal (information processing apparatus) such as a personal computer (PC), a tablet terminal, or a smartphone. The client terminal 102 can set settings so as to enable the MFP 101 to connect to the intermediate server 103 via the network line 105, and can request the intermediate server 103 to issue a scan job.

The intermediate server 103 manages information of the scanning apparatus and a scan job. The intermediate server 103 receives, via the network line 105, a request to register the scanning apparatus, receives a request to issue a scan job from the client terminal 102 via the network line 105, receives, from the MFP 101 via the network line 105, a request to acquire a scan job, and receives, from the MFP 101 via the network line 105, a request to transmit a scanned image.

The intermediate server 103 is also manages a print job and can manage information of a printing apparatus. The intermediate server 103 receives, from the printing apparatus or the client terminal 102 via the network line 105, a request to register the printing apparatus, and manages information of the printing apparatus.

The intermediate server 103 can transmit, to the registered printing apparatus, a print job received from the client terminal 102 or a print service on another network, and cause the printing apparatus to perform processing of printing print data. Since the MFP 101 has the scan function and the print function, the MFP 101 can be registered as both the scanning apparatus and the printing apparatus in the intermediate server 103. In the present embodiment, since the intermediate server 103 relays scan data from the MFP 101, the intermediate server 103 is referred to with the word “intermediate”. However, the intermediate server 103 is a service providing server that provides a scan service and a print service and is on a cloud system.

The intermediate server 103 performs scanning and printing and manages authentication information for permitting or restricting a request to register an apparatus if necessary.

The storage server 104 is a service that manages an electronic file including image data. The storage server 104 stores and manages an electronic file received from the MFP 101. The storage server 104 manages a request to store a new electronic file, and authentication information for restricting a request to access each managed electronic file if necessary.

A plurality of MFPs 101, a plurality of client terminals 102, and a plurality of storage servers 104 may be present in the system according to the present embodiment. The network line 105 may be of any type, such as an intranet or the Internet or a wired line or a wireless line, as long as the MFP 101, the client terminal 102, the intermediate server 103, and the storage server 104 are communicable with each other.

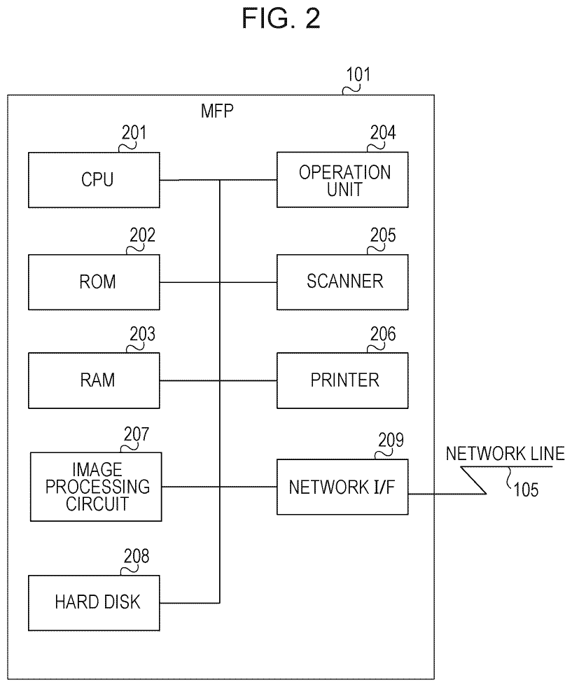

Next, an example of a hardware configuration of the MFP 101 will be described with reference to FIG. 2.

FIG. 2 is a diagram illustrating the example of the hardware configuration of the MFP 101.

The MFP 101 includes a CPU 201, a ROM 202, a RAM 203, an operation unit 204, the scanner 205, a printer 206, an image processing circuit 207, a hard disk 208, and a network interface (I/F) 209. The MFP 101 may include another storage apparatus such as a solid-state drive (SSD) or an embedded MultiMediaCard (eMMC) memory, instead of or in addition to the hard disk.

The CPU 201 is a control circuit that controls the entire system using a program stored in the ROM 202 and a memory area of the RAM 203.

The operation unit 204 is a circuit that performs a user's operation.

The scanner 205 reads an image on a document and sequentially outputs the read image for each page.

The printer 206 performs printing on a recording medium based on the image.

The image processing circuit 207 includes a large-capacity image memory, an image rotating circuit, a resolution magnification circuit, and an encoding and decoding circuit for MH, MR, MMR, JBIG, and JPEG, and can perform various types of image processing such as shading, trimming, and masking.

The hard disk 208 (hard disk drive (HDD)) is a large-capacity recording medium connected via an interface (I/F) such as SCSI or IDE. The MFP 101 may include another storage apparatus such as a solid-state drive (SSD) or an embedded MultiMediaCard (eMMC) memory, instead of or in addition to the HDD.

The network I/F 209 is a circuit for connection to the network line 105.

The scanner 205, the printer 206, and the image processing circuit 207 are connected to each other via a high-speed video bus different from a CPU bus from the CPU 201, and are capable of transmitting an image at high speed. In the MFP 101, the image processing circuit 207 processes an image read by the scanner 205.

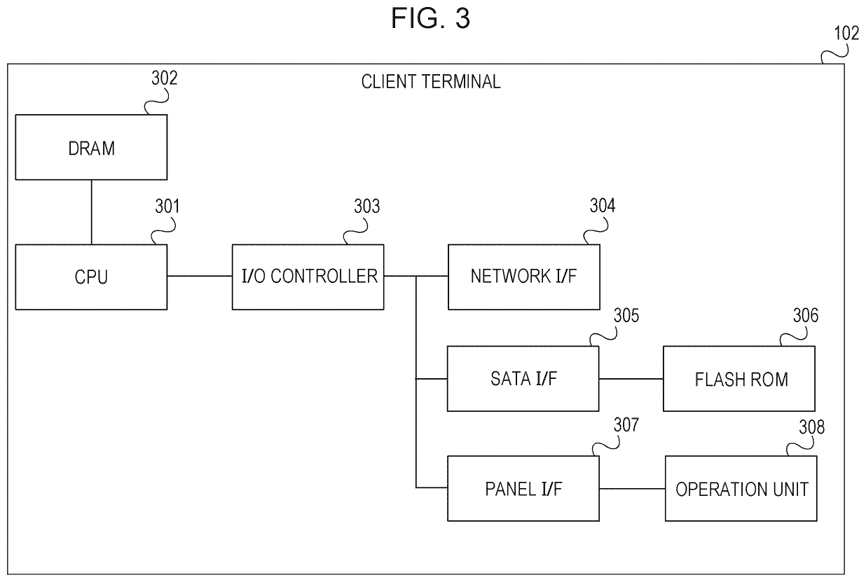

Next, an example of a hardware configuration of the client terminal 102 will be described with reference to FIG. 3.

FIG. 3 is a diagram illustrating the example of the hardware configuration of the client terminal 102.

The client terminal 102 includes a CPU 301, a DRAM 302, an I/O controller 303, a network I/F 304, a Serial Advanced Technology Attachment (SATA) I/F 305, a flash ROM 306, a panel I/F 307, and an operation unit 308. The CPU 301 is connected to the DRAM 302 via a bus.

The DRAM 302 is used by the CPU 301 as a work memory for temporarily storing program data representing operation instructions in the process of operation by the CPU 301 and data to be processed.

The CPU 301 is connected to the I/O controller 303 via the bus.

The network I/F 304 is connected to the I/O controller 303.

A wired LAN device, a wired LAN device, or a data communication device is connected to the network I/F 304.

The CPU 301 implements communication on the network line 105 by controlling the wired LAN device, the wireless LAN device, or the data communication device via the network I/F 304.

The I/O controller 303 performs input/output on various devices in accordance with an instruction from the CPU 301. The SATA I/F 305 is connected to the I/O controller 303. The flash ROM 306 is connected to the SATA I/F 305. The flash ROM 306 may not be connected to the SATA I/F 305 and a large-capacity storage unit may be connected to the SATA I/F 305.

The CPU 301 uses the flash ROM 306 to permanently store a program such as a push scan application, setting values, and the like.

The panel I/F 307 is connected to the I/O controller 303. The CPU 301 implements input/output for a user on the operation unit 308 of the client terminal 102 connected to the CPU 301 via the panel I/F 307.

An example of the operation unit 308 is a touch panel. As the operation unit 308, a display that performs display, and an input device such as a keyboard for performing input may be connected to the panel I/F 307.

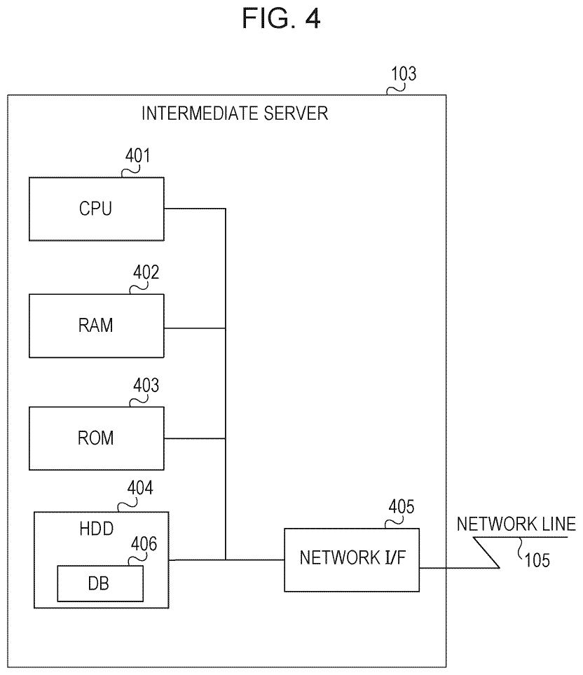

Next, an example of a hardware configuration of the intermediate server 103 will be described with reference to FIG. 4.

FIG. 4 is a diagram illustrating the example of the hardware configuration of the intermediate server 103.

The intermediate server 103 includes a CPU 401, a RAM 402, a ROM 403, an HDD 404, and a network I/F 405. The CPU 401 is a central processing unit that controls the operation of the entire intermediate server 103.

The RAM 402 is a volatile memory. The RAM is used by the CPU 401 as a work memory for temporarily storing program data representing operation instructions in the process of operation by the CPU 401 and data to be processed.

The ROM 403 is a nonvolatile memory. A boot program for the CPU 401 is stored in the ROM 403.

The HDD 404 stores various programs and various data. The intermediate server 103 may include another storage apparatus such as a solid-state drive (SSD) or an embedded MultiMediaCard (eMMC) memory, instead of or in addition to the HDD. A database (DB) 406 in the HDD 404 is used to manage information necessary for execution of a scan job.

The CPU 401 communicates with the other apparatuses on the network line 105 via the network I/F 405.

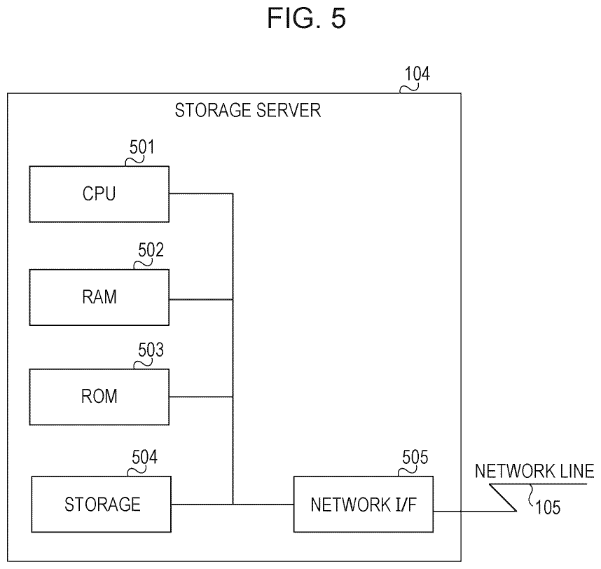

Next, an example of a hardware configuration of the storage server 104 will be described with reference to FIG. 5.

FIG. 5 is a diagram illustrating the example of the hardware configuration of the storage server 104.

The storage server 104 includes a CPU 501, a RAM 502, a ROM 503, storage 504, and a network I/F 505. The CPU 501 is a central processing unit that controls the operation of the entire storage server 104.

The RAM 502 is a volatile memory. The RAM 502 is used by the CPU 501 as a work memory for temporarily storing program data representing operation instructions in the process of operation by the CPU 501 and data to be processed.

The ROM 503 is a nonvolatile memory. A boot program for the CPU 501 is stored in the ROM 503.

The storage 504 is a large-capacity storage apparatus (for example, a hard disk drive (HDD)) having a capacity larger than that of the RAM 502. The storage 504 is used to store an electronic file. The storage 504 may be a solid-state drive (SSD) or may be replaced with another storage apparatus having a function equivalent to a hard disk drive.

The CPU 501 communicates with the other apparatuses on the network line 105 via the network I/F 505.

Each of the intermediate server 103 and the storage server 104 may be implemented by a single computer or may be implemented by a plurality of computers. For example, the intermediate server 103 and the storage server 104 may be implemented by using a cloud computing technique.

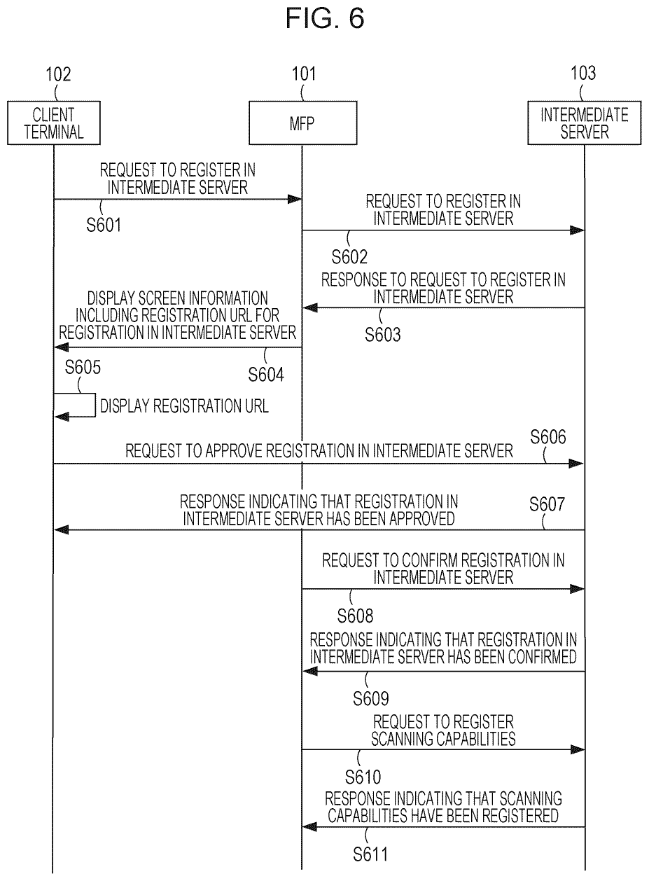

An example of a sequence for registering the MFP 101 in the intermediate server 103 and enabling the intermediate server 103 to manage a scan job of the MFP 101 will be described with reference to FIG. 6.

FIG. 6 is a diagram illustrating an example of a sequence for registration of the MFP in the intermediate server according to one or more aspects of the present disclosure. In FIG. 6, processing by the client terminal 102 is implemented by the CPU 301 of the client terminal 102 reading and executing a program stored in the flash ROM 306 or the like, processing by the MFP 101 is implemented by the CPU 201 of the MFP 101 reading and executing a program stored in the ROM 202 or the like, and processing by the intermediate server 103 is implemented by the CPU 401 of the intermediate server 103 reading and executing a program stored in the HDD 404 or the like.

First, the user uses the client terminal 102 to perform an operation for transmitting a request to register the MFP 101 in the intermediate server 103. Upon receiving this operation, the client terminal 102 transmits, to the MFP 101, the request to register the MFP 101 in the intermediate server 103 (S601).

Upon receiving the request in S601, the MFP 101 transmits, to the intermediate server 103, the request to register the MFP 101 in the intermediate server 103 (S602).

Upon receiving the request in S602, the intermediate server 103 transmits, to the MFP 101, a response to the request to register the MFP 101 in the intermediate server 103 (S603). The response in S603 includes a registration URL for registration in the intermediate server 103.

Upon receiving the response in S603, the MFP 101 transmits, to the client terminal 102, display screen information including the registration URL for registration in the intermediate server 103 (S604).

Upon receiving the display screen information in S604, the client terminal 102 displays, on the operation unit 308, a screen (not illustrated) including the registration URL in accordance with the display screen information (S605).

The user operates the client terminal 102 to access the registration URL displayed in S605. In response to the operation, the client terminal 102 transmits, to the intermediate server 103, a request to approve the registration in the intermediate server 103 (S606). The request to approve the registration in the intermediate server 103 includes authentication information of the intermediate server 103. The authentication information indicates a user who has the authority to use the intermediate server 103. The authentication information is registered in the intermediate server 103 in advance by the user.

Upon receiving the request to approve the registration in S606, the intermediate server 103 performs a process of registering the MFP 101 based on the request to approve the registration, and transmits, to the client terminal 102, a response indicating that the registration in the intermediate server 103 has been approved (S607). The intermediate server 103 provides a scanner ID to the MFP 101 in this registration process and registers the scanner ID in the DB 406. The scanner ID is identification information used for identifying the registered scanner by the intermediate server 103.

The MFP 101 transmits, to the intermediate server 103, a request to confirm the registration in the intermediate server 103 (S608).

Upon receiving the request to confirm the registration in S608, the intermediate server 103 transmits, to the MFP 101, a response indicating that the registration in the intermediate server 103 has been confirmed (S609). The response in S609 includes the scanner ID. Upon receiving the response in S609, the MFP 101 holds the scanner ID included in the response in, for example, the HDD 208, and uses the scanner ID to acquire the scan job from the intermediate server 103.

After the MFP 101 confirms, based on the response in S609, that the MFP 101 has been registered in the intermediate server 103 (the MFP 101 has received the response including the scanner ID), the MFP 101 transmits, to the intermediate server 103, a request to register scanning capabilities (S610). The request to register the scanning capabilities includes the scanner ID acquired in S609 and information indicating the scanning capabilities of the MFP 101.

Upon receiving the request to register the scanning capabilities in S610, the intermediate server 103 additionally registers, in the DB 406, data in which the scanner ID is associated with the scanning capabilities as indicated by Table 1 described later, and transmits, to the MFP 101, a response indicating that the scanning capabilities have been registered (S611).

Therefore, the client terminal 102 can acquire supported setting information from the intermediate server 103 before instructing the MFP 101 to perform scanning. When the scanning capabilities, such as the device configuration of the MFP 101 or settings, are changed, the processing in S610 and S611 may be performed to register the scanning capabilities again.

At this point of time, the MFP 101 becomes registered in the intermediate server 103, and the transmission of a scanned image via the intermediate server 103 becomes available.

In this example, when the MFP 101 is registered in the intermediate server 103, the MFP 101 transmits information including the scanning capabilities of the MFP 101 to the intermediate server 103 and registers the information including the scanning capabilities in the intermediate server 103. However, in S602, the MFP 101 may transmit, to the intermediate server 103, a registration request including the information including the scanning capabilities of the MFP 101.

Table 1 indicates an example of a table used by the intermediate server 103 to manage scanning capabilities of each scanner.

TABLE 1

| Scanner ID | Scanning capabilities |
|---|---|
| scanner-A | source: platen/feeder |
| | size: a4, a3, letter, legal, . . . |
| | color: cl, bw, gs . . . |
| scanner-B | source: platen/feeder |
| | size: a4, a3 |
| | color: cl, bw . . . |
| scanner-C | source: platen |
| | size: letter, legal |
| | color: cl, bw . . . |

In Table 1, in each record, a “scanner ID” identifying a scanner and “scanning capabilities” of the scanner are registered.

The scanning capabilities will be described below using, as an example, a record in which a scanner ID is “scanner-A” in Table 1.

“Source” indicates reading sources supported, “platen” indicates that reading with a pressing plate is supported, and “feeder” indicates that reading with a feeder is supported.

“Size” indicates sheet sizes supported, “a4” indicates that an A4 sheet is supported, “a3” indicates that an A3 sheet is supported, “letter” indicates that a letter size sheet is supported, and “legal” indicates that a legal size sheet is supported.

“Color” indicates color modes supported, “cl” indicates that color is supported, “bw” indicates that black and white is supported, and “gs” indicates that gray scale is supported.

It is assumed that other scanning capabilities are described in a similar manner.

A column indicating a client ID may be added to the table such that an available scanner can be managed for each client terminal. In addition, a column based on a purpose of use may be present in the table.

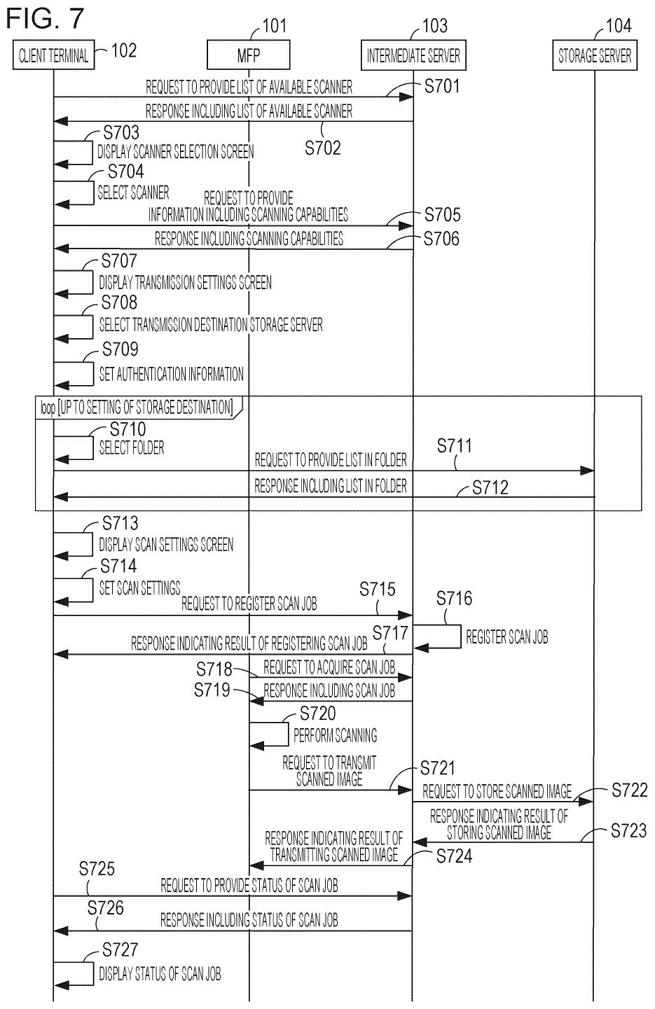

Next, an example of a sequence in which the MFP 101 transmits a scanned image to the storage server 104 via the intermediate server 103 will be described with reference to FIGS. 7 to 12. It is assumed that each communication is authenticated in this sequence.

FIG. 7 is a diagram illustrating an example of a sequence for push scanning according to one or more aspects of the present disclosure.

In FIG. 7, processing by the client terminal 102 is implemented by the CPU 301 of the client terminal 102 reading and executing a program stored in the flash ROM 306 or the like. Processing by the MFP 101 is implemented by the CPU 201 of the MFP 101 reading and executing a program stored in the ROM 202 or the like. Processing by the intermediate server 103 is implemented by the CPU 401 of the intermediate server 103 reading and executing a program stored in the HDD 404 or the like. Processing by the storage server 104 is implemented by the CPU 501 of the storage server 104 reading and executing a program stored in the storage 504 or the like.

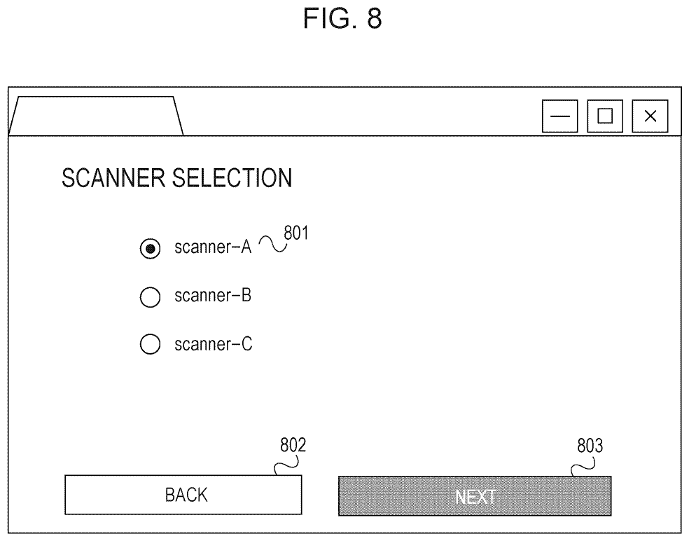

FIGS. 8 to 12 are diagrams illustrating examples of screens displayed on the client terminal 102 according to one or more aspects of the present disclosure. The screens illustrated in FIGS. 8 to 12 may be displayed via a web browser executed in the client terminal 102 or may be displayed by a dedicated scanning application. A process performed by pressing a “back” button on each of the screens is only to display a previous screen, and will not be described.

First, the client terminal 102 transmits, to the intermediate server 103, a request to provide a list of an available scanner (S701).

Upon receiving the request in S701, the intermediate server 103 extracts the list of the available scanner based on registered information as indicated by Table 1 and transmits a response including the list of the available scanner to the client terminal 102 (S702).

Upon receiving the response in S702, the client terminal 102 displays, on the operation unit 308, the list of the scanner as illustrated in FIG. 8 based on the received response (S703).

FIG. 8 will be described below.

FIG. 8 is a diagram illustrating an example of a scanner selection screen of the client terminal according to one or more aspects of the present disclosure.

As illustrated in FIG. 8, a list 801 of selectable scanners is displayed on the scanner selection screen. When the user selects, from the list 801, a scanner to be used and presses a “next” button 803, the client terminal 102 determines that the selection of the scanner has been set.

A “back” button 802 is a button for returning the screen to the previous screen.

Return to the description of FIG. 7.

When the user performs, on the scanner selection screen displayed in S703, an operation of selecting the scanner to be used, the client terminal 102 receives the operation of selecting the scanner (S704).

The client terminal 102 transmits, to the intermediate server 103, a request to provide information including scanning capabilities of the scanner selected in S704 (S705). The request in S705 includes a scanner ID (that is, the scanner ID of the scanner selected in S704) of the scanner of which the scanning capabilities are to be acquired.

Upon receiving the request in S705, the intermediate server 103 transmits, to the client terminal 102, a response including the scanning capabilities associated with the scanner ID included in the request transmitted in S705 (S706).

Upon receiving the response in S706, the client terminal 102 receives various settings (S707 to S714). The settings may not be received in the order indicated in the sequence illustrated in FIG. 7. The settings will be described below in detail.

First, transmission destination settings in S707 to S712 will be described.

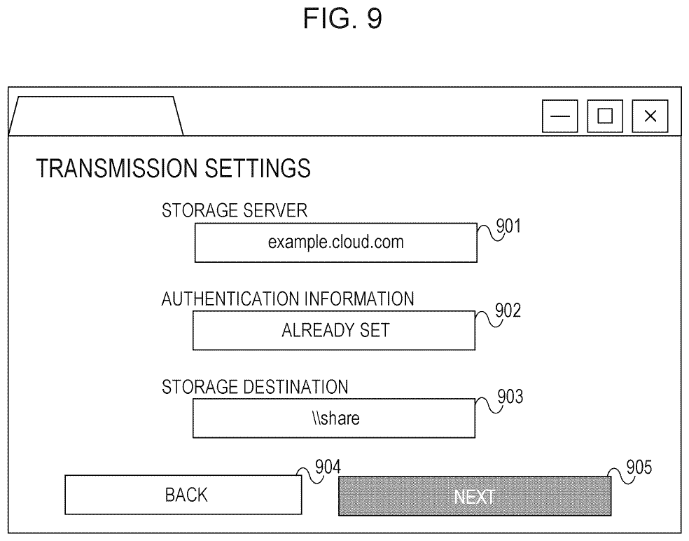

The client terminal 102 displays a settings screen for transmission on the operation unit 308 as illustrated in FIG. 9 (S707).

FIG. 9 will be described.

FIG. 9 is a diagram illustrating an example of the transmission settings screen of the client terminal according to one or more aspects of the present disclosure.

On the transmission settings screen, when a “storage server” button 901 is pressed, a dialog screen (not illustrated) is displayed and the user can set a storage server that is a transmission destination.

Examples of a method of setting the storage server include a method of selecting the storage server from a destination list prepared in advance and a method of directly entering a character string such as a host name or an IP address.

When an “authentication information” button 902 is pressed, a dialog screen (not illustrated) is displayed and the user can set authentication information for the storage server set by using the “storage server” button 901. Examples of a method of setting the authentication information include a method of acquiring an access token for OAuth authentication and a method of directly entering a user name and a password. Information displayed on the “authentication information” button 902 may be information indicating whether the authentication information has already been set, or may be a part of the authentication information in which the user name and the like have been set.

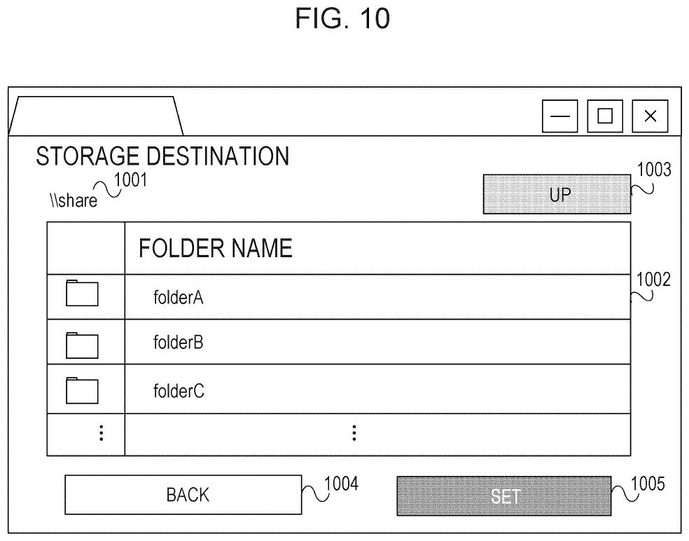

When a “storage destination” button 903 is pressed, the user can set, on a screen illustrated in FIG. 10 described later, a storage destination where a scanned document is to be stored in the storage server set by using the “storage server” button 901.

When a “next” button 905 is pressed after the setting using the buttons 901 to 903, the client terminal 102 determines that the transmission destination settings have been set. A “return” button 904 is a button for returning the screen to the previous screen. Return to the description of FIG. 7.

When the user performs an operation of selecting, from the transmission settings screen as illustrated in FIG. 9, a transmission destination storage server (when the user presses the “storage server” button 901 and selects the storage server), the client terminal 102 receives the operation of selecting the transmission destination storage server (S708). A sequence in a case that the storage server 104 is selected as a transmission destination in S708 will be described below.

The client terminal 102 receives a user's operation for setting authentication information for the storage server 104 selected in S708 (S709). Specifically, when the “authentication information” button 902 is pressed, the client terminal 102 displays, on the operation unit 308, a setting screen (not illustrated) for setting the authentication information for the storage server 104 selected in S708.

When the user performs an operation of entering the authentication information on the setting screen, the client terminal 102 receives the operation. In a case where the authentication information has already been set by a previous operation or the like (in a case where “already set” is displayed on the “authentication information” button 902), S709 may be omitted. The access token or the like for OAuth authentication may be acquired by communication with a separate authentication server. In this case, an operation for setting the authentication information received from the user includes an operation of entering the user name and a password into the authentication server or biometric authentication. In addition, the client terminal 102 may acquire the access token from the authentication server via the intermediate server 103. In the present embodiment, it is assumed that authentication is performed using the access token as the authentication information, but another authentication method such as password authentication may be performed. The client terminal 102 may have a function of confirming whether the set authentication information is valid.

The client terminal 102 receives a user's operation for setting a storage destination in the storage server 104 selected in S708 (S710 to S712).

Specifically, when the “storage destination” button 903 is pressed, the client terminal 102 displays, on the operation unit 308, a screen as illustrated in FIG. 10 as a setting screen for the storage destination in the storage server 104 selected in S708. FIG. 10 will be described.

FIG. 10 is a diagram illustrating an example of a storage destination folder selection screen of the client terminal according to one or more aspects of the present disclosure.

A storage destination 1001 currently set is displayed on the storage destination folder selection screen. A folder structure 1002 of the storage destination 1001 currently set is also displayed on the storage destination folder selection screen. When the user selects a folder displayed in the folder structure 1002, a folder structure of a child layer of the folder is displayed. When an “up” button 1003 is pressed, a folder structure of a parent layer of the folder currently displayed in the folder structure 1002 of the storage destination 1001 is displayed. Although described later in detail, the folder structure displayed in this case is acquired by the client terminal 102 transmitting, to the storage server 104, a request to provide a list in the folder (S711) and the storage server 104 transmitting a response including the list in the folder according to the request to provide the list (S712). When the user presses a “set” button 1005, the client terminal 102 determines that the storage destination displayed in the storage destination 1001 has been set. A “back” button 1004 is a button for returning the screen to the previous screen. Return to the description of FIG. 7.

When the user performs an operation of selecting a folder from the folder structure 1002 of the screen as illustrated in FIG. 10, the client terminal 102 receives the operation (S710). Further, the client terminal 102 transmits, to the storage server 104, a request to provide a list in the folder selected in S710 (S711). The request in S711 includes identification information of the folder selected in S710. The request to provide the list may be transmitted via the intermediate server 103. Upon receiving the request to provide the list in S711, the storage server 104 transmits a response including the list in the folder according to the request to provide the list (S712). Upon receiving the response, the client terminal 102 displays, on the operation unit 308, a setting screen for a storage destination based on the list included in the response and receives an operation of selecting a folder or setting the storage destination.

When the user selects a folder (when the folder is selected or the up button 1003 or the back button 1004 is pressed), the client terminal 102 returns the process to S710. When the “set” button 1005 is pressed, the client terminal 102 determines that the selection of the folder that is a storage destination has been set, and advances the process to S713.

Further, the client terminal 102 receives scan settings (S713 and S714). Specifically, the client terminal 102 displays, on the operation unit 308, a settings screen for scanning (S713).

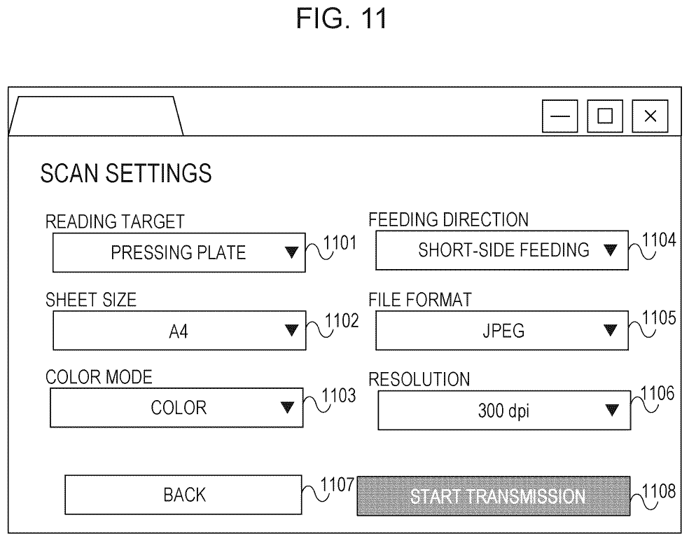

FIG. 11 will be described below.

FIG. 11 is a diagram illustrating an example of the scan settings screen of the client terminal according to one or more aspects of the present disclosure.

On the scan settings screen, buttons 1101 to 1106 for setting reading settings (scan settings) are displayed, and a current setting value is displayed on each of the buttons 1101 to 1106. The “reading target” button 1101 is for setting a reading target (pressing plate or feeder). The “sheet size” button 1102 is for setting the size (A4 size, A3 size, or the like) of a sheet to be read. The “color mode” button 1103 is for setting a color mode (color, white and black, or the like) for scanning. The “feeding direction” button 1104 is for setting a direction (vertical feeding direction or horizontal feeding direction) in which a document is fed. The “file format” button 1105 is for setting a file format (JPEG, PDF, or the like) of an image to be transmitted. The “resolution” button 1106 is for setting the resolution (300 dpi, 600 dpi, or the like) for scanning.

When a “start transmission” button 1108 is pressed, the client terminal 102 determines that the scan settings have been set. A “back” button 1107 is for returning the screen to the previous screen.

Return to the description of FIG. 7.

Various setting items and settable values displayed on the scan settings screen as illustrated in FIG. 11 are controlled based on the scanning capabilities included in the response from the intermediate server 103 in S706. In the example illustrated in FIG. 11, settings items for the reading target, the sheet size, the color mode, the feeding direction, the file format, and the resolution are displayed, but are not limited thereto.

When the user performs an operation for setting the scan settings on the scan settings screen, the client terminal 102 receives the operation (S714).

When the “start transmission” button 1108 is pressed to set the scan settings on the scan settings screen, each of the settings received in S707 to S714 is completed.

When each of the settings received in S707 to S714 is completed, the client terminal 102 transmits, to the intermediate server 103, a request to register a scan job (S715). The request to register the scan job includes the scanner ID of the scanner selected in S704, the transmission destination settings set in S708 to S712 that include information of the storage server, the authentication information and information of the storage destination, and the scan settings set in S714.

Upon receiving the request to register the scan job in S715, the intermediate server 103 issues a scan job ID (identification information of the scan job) according to the request to register the scan job, and registers the scan job in the DB 406 as indicated by Table 2 described later (S716).

Thereafter, the intermediate server 103 transmits, to the client terminal 102, a response indicating a result of registering the scan job (S717). The response indicating the result of the registration in S717 includes the scan job ID. The client terminal 102 receives the response in S717. In response to the reception of the response, the client terminal 102 may display, on the operation unit 308, information indicating that the scan job has been registered.

The MFP 101 transmits, to the intermediate server 103, a request to acquire the scan job (S718). The request in S718 includes the scanner ID received and held in S609 illustrated in FIG. 6. For example, the MFP 101 periodically transmits the request to acquire the scan job. The MFP 101 may transmit, in accordance with a user's operation from the operation unit 204, the request to acquire the scan job.

Upon receiving the request to acquire the scan job in S718, the intermediate server 103 transmits, to the MFP 101 based on the scanner ID included in the request to acquire the scan job and information as indicated by Table 2 (described later), a response including the scan job associated with the scanner ID included in the request to acquire the scan job (S719). The scan job included in the response in S719 includes the scan job ID and the scan settings. If the scan job associated with the scanner ID included in the request to acquire the scan job is not present, the scan job is not included in the response in S719.

In a case where the scan job is included in the response, the MFP 101 that has received the response in S719 extracts the scan settings from the scan job included in the response and performs scanning using the scan settings (S720). It is assumed that a document to be scanned is placed on the MFP 101 before the scanning is performed.

When the scanning in S720 is ended, the MFP 101 transmits, to the intermediate server 103, a request to transmit a scanned image (S721). The request to transmit the scanned image includes scanned image data obtained by the scanning in S720 and the scan job ID included in the response transmitted from the intermediate server 103 in S719.

Upon receiving the request to transmit the scanned image in S721, the intermediate server 103 identifies, based on the information as indicated by Table 2 (described later), the transmission destination settings from the scan job ID included in the request to transmit the scanned image in S721, and transmits, to the storage server 104 associated with the transmission destination settings, a request to store the scanned image included in the request to transmit the scanned image in S721 (S722). The request to store the scanned image in S722 includes the scanned image, the storage destination information and the authentication information that are included in the transmission destination settings extracted based on the information as indicated by Table 2 (described later). The authentication information is an access token or the like.

Upon receiving the request to store the scanned image in S722, the storage server 104 stores the scanned image included in the request to store the scanned image, and transmits, to the intermediate server 103, a response indicating a result of storing the scanned image (S723).

Upon receiving the response indicating the result of storing the scanned image in S723, the intermediate server 103 transmits, to the MFP 101, a response indicating a result of transmitting the scanned image (S724).

The client terminal 102 transmits, to the intermediate server 103, a request to provide the status of the scan job (S725). The request in S725 includes the scan job ID included in the response from the intermediate server 103 in S719. In S725, the request is periodically transmitted until the status of the scan job changes to a complete status after the transmission of the response in S717.

After receiving the request to provide the status of the scan job in S725, the intermediate server 103 identifies the status (job status) of the scan job from the scan job ID included in the request in S725 and transmits, to the client terminal 102, a response including the status of the scan job (S726).

After receiving the response in S726, the client terminal 102 displays, on the operation unit 308, the status of the scan job included in the response (S727).

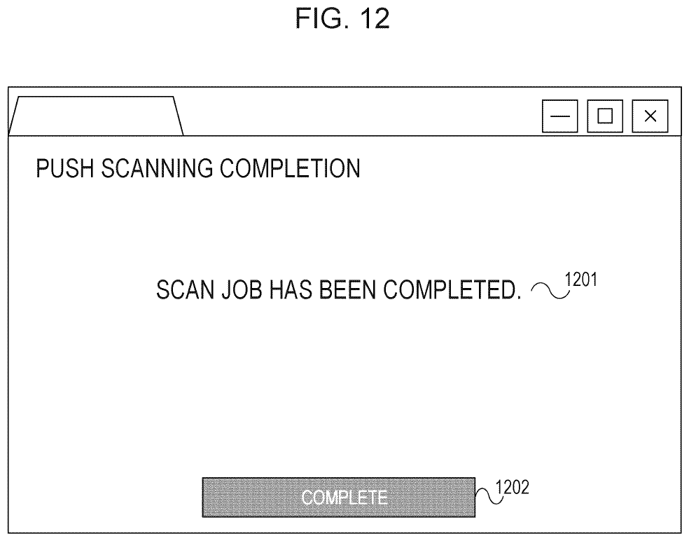

FIG. 12 will be described below.

FIG. 12 is a diagram illustrating an example of a push scanning completion screen of the client terminal according to one or more aspects of the present disclosure.

On the push scanning completion screen, a message indicating that the scan job has been completed is displayed in a scan job result area 1201. If an error of the scan job occurs, an error message or an error code is displayed in the scan job result area 1201. A “complete” button 1202 is a button for closing the push scanning completion screen.

Return to the description of FIG. 7.

The request to acquire the scan job in S718 may be periodically made in a background, or may be made when the user operates the MFP 101 to instruct to make the request. In a configuration in which a scan job is acquired when the user operates the MFP 101 to instruct to acquire the scan job, the MFP 101 may display, on the operation unit 204, a list of one or more scan jobs acquired from a response including the one or more scan jobs in S719, receive selection of a scan job by the user on the operation unit 204, and execute the selected scan job. In a configuration in which a scan job is periodically acquired, when the user logs into the MFP 101, the MFP 101 may display, on the operation unit 204, a list of one or more scan jobs acquired and stored in the HDD 208, receive selection of a scan job by the user on the operation unit 204, and execute the selected scan job.

Table 2 indicates an example of a table used by the intermediate server 103 to manage scan jobs.

TABLE 2

| Scan | | | | |
|---|---|---|---|---|
| job | Scanner | Transmission destination | Scan | Job |
| ID | ID | settings | settings | status |
| 1 | scanner- | server: example.cloud.com | source: platen | ready |
| | A | dest: ¥¥share¥folderA | size: a4 | |
| | | token: abc123 | color: cl | |
| | | | . . . | |
| 2 | scanner- | server: example.cloud.com | source: platen | sending |
| | B | dest: ¥¥userA¥document | size: a3 | |
| | | token: def456 | color: bw | |
| | | | . . . | |
| 3 | scanner- | server: sample.cloud.com | source: feerder | complete |
| | C | dest: ¥¥userB¥temp | size: letter | |
| | | token: xyz789 | color: cl | |
| | | | . . . | |

In each record of the table indicated by Table 2, a scan job ID identifying a scan job, a scanner ID identifying a scanner that executes the scan job, transmission destination settings, scan settings, and the status of the scan job are registered. Each column of the table will be described using, as an example, a record in which a scan job ID is “1” in Table 2. A scanner ID of a scanner that executes a scan job is “scanner-A”. In the transmission destination settings, “server” indicates that a transmission destination storage server is “example.cloud.com”, “dest” indicates that a storage destination is “¥¥share¥folderA”, and “token” indicates that authentication information is “abc123”. In the scan settings, “source” indicates a reading source, “platen” indicates settings for reading from the pressing plate, “size” indicates the size of a sheet to be read, “a4” indicates that an A4 sheet is read, “color” indicates the color mode, and “cl” indicates that the sheet is read in color. It is assumed that other scan settings are described in a similar manner. Since the job status indicates “ready”, the job status indicates that the scan job is being prepared. A column indicating a client ID may be added to the table such that a scan job can be managed for each client terminal. In addition, a column based on a purpose of use may be present in the table.

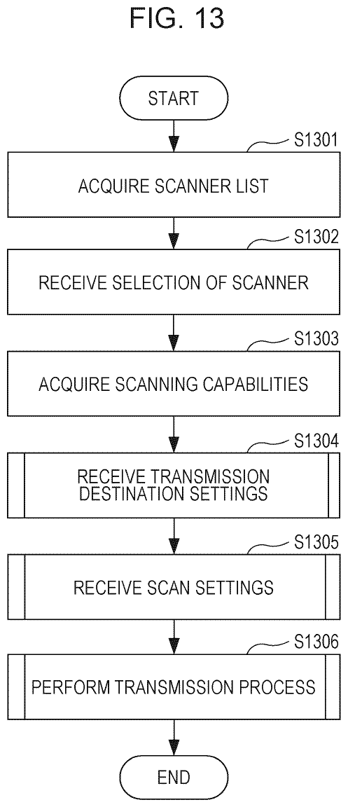

Next, a procedure from the acquisition of a scanner list to the completion of the transmission of a scanned image by the client terminal 102 according to one or more aspects of the present disclosure will be described with reference to FIG. 13.

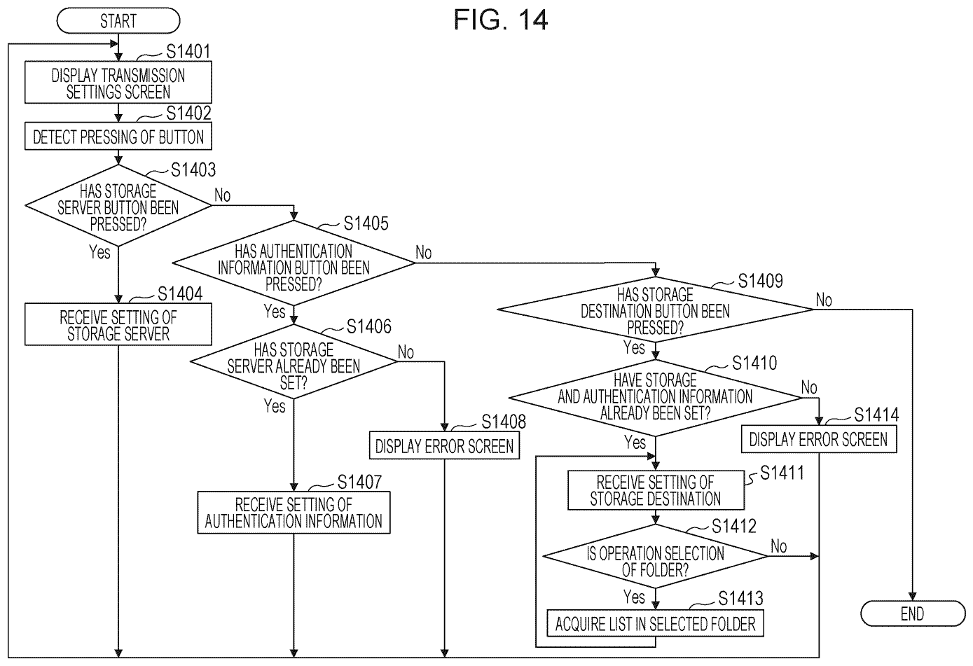

FIG. 13 is a flowchart of an example of a process from the acquisition of a scanner list to the completion of the transmission of a scanned image by the client terminal 102 according to one or more aspects of the present disclosure. The process by the client terminal 102 in the flowchart of FIG. 13 and flowcharts of FIGS. 14 to 16 (described later) is implemented by the CPU 301 of the client terminal 102 reading and executing a program stored in the flash ROM 306 or the like.

In S1301, the client terminal 102 acquires a scanner list from the intermediate server 103.

Next, in step S1302, the client terminal 102 displays, on the operation unit 308, the scanner selection screen as illustrated in FIG. 8 based on the scanner list acquired in S1301, and receives selection of a scanner to be used from the user. Upon receiving the selection of the scanner, the client terminal 102 advances the process to S1303.

In S1303, the client terminal 102 acquires, from the intermediate server 103, scanning capabilities of the scanner selected in S1302.

Next, in S1304, the client terminal 102 receives transmission destination settings from the user. S1304 will be described later in detail with reference to FIG. 14.

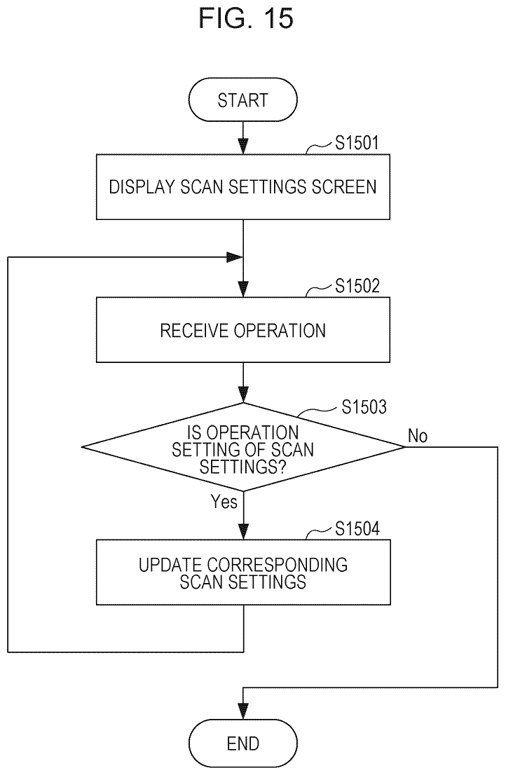

Next, in S1305, the client terminal 102 receives scan settings from the user. S1305 will be described later in detail with reference to FIG. 15.

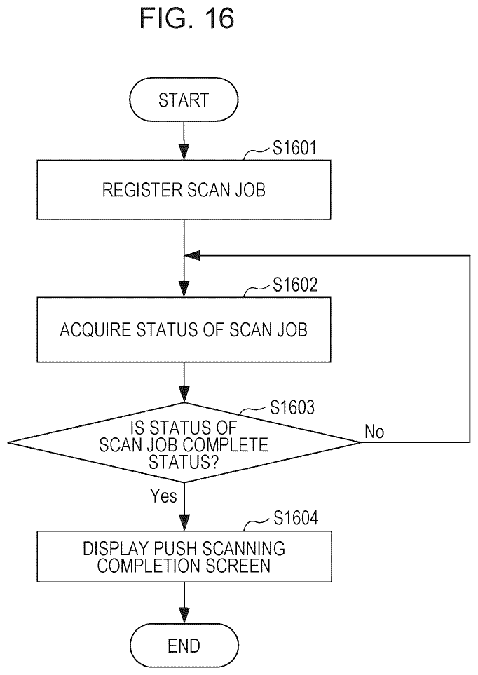

Next, in S1306, the client terminal 102 performs a transmission process via the intermediate server 103 based on the settings received in S1304 and S1035. S1306 will be described later in detail with reference to FIG. 16. After the transmission process, the client terminal 102 ends the process in the flowchart of FIG. 13.

Next, a procedure for the transmission destination settings by the client terminal 102 in S1304 illustrated in FIG. 13 will be described in detail with reference to FIG. 14.

FIG. 14 is a flowchart illustrating an example of a transmission destination setting process by the client terminal 102 according to one or more aspects of the present disclosure.

In S1401, the client terminal 102 displays, on the operation unit 308, the transmission settings screen as illustrated in FIG. 9.

Next, in S1402, the client terminal 102 detects pressing of a button on the transmission settings screen by the user and advances the process to S1403.

In S1403, the client terminal 102 determines whether the button detected as having been pressed in S1402 is the “storage server” button 901.

If the button detected as having been pressed is the “storage server” button 901 (Yes in S1403), the client terminal 102 advances the process to S1404.

In S1404, the client terminal 102 displays a dialog (not illustrated), receives setting of a transmission destination storage server from the user, and returns the process to S1401.

On the other hand, if the button detected as having been pressed is not the “storage server” button 901 (No in S1403), the client terminal 102 advances the process to S1405.

In S1405, the client terminal 102 determines whether the button detected as having been pressed in S1402 is the “authentication information” button 902.

If the button detected as having been pressed is the “authentication information” button 902 (Yes in S1405), the client terminal 102 advances the process to S1406.

In S1406, the client terminal 102 confirms whether the storage server has already been set.

If the storage server has already been set (Yes in S1406), the client terminal 102 advances the process to S1407.

In S1407, the client terminal 102 displays a dialog (not illustrated), receives, from the user, setting of authentication information for the storage server set in S1404, and returns the process to S1401.

On the other hand, if the storage server has not been set (No in S1406), the client terminal 102 advances the process to S1408.

In S1408, the client terminal 102 displays an error screen (not illustrated) on the operation unit 308 and returns the process to S1401.

If the button detected as having been pressed is not the “authentication information” button 902 (No in S1405), the client terminal 102 advances the process to S1409.

In S1409, the client terminal 102 determines whether the button detected as having been pressed in S1402 is the “storage destination” button 903.

If the button detected as having been pressed in S1402 is the “storage destination” button 903 (Yes in S1409), the client terminal 102 advances the process to S1410.

In S1410, the client terminal 102 confirms whether transmission destination storage and authentication information have already been set.

If the transmission destination storage and the authentication information have already been set (Yes in S1410), the client terminal 102 advances the process to S1411.

In S1411, the client terminal 102 displays the storage destination folder selection screen as illustrated in FIG. 10 on the operation unit 308, receives an operation of setting a storage destination from the user, and advances the process to S1412.

In S1412, the client terminal 102 determines whether the operation received in S1411 is selection of a folder.

If the received operation is the selection of the folder (Yes in S1412), the client terminal 102 advances the process to S1413.

In S1413, the client terminal 102 acquires a list in the folder selected in S1412, displays a folder structure based on the list in the folder structure 1002 on the storage destination folder selection screen as illustrated in FIG. 10, and returns the process to S1411.

On the other hand, if the operation received in S1411 is not the selection of the folder (No in S1412), the client terminal 102 returns the process to S1411.

If the transmission destination storage and the authentication information have not been set (No in S1410), the client terminal 102 advances the process to S1414.

In S1414, the client terminal 102 displays an error screen (not illustrated) and returns the process to S1401.

If the button detected as having been pressed in S1402 is not the “storage destination” button 903 (No in S1409), the client terminal 102 ends the process in the flowchart of FIG. 14.

Next, a procedure for a scan setting process by the client terminal 102 in S1305 will be described in detail with reference to FIG. 15.

FIG. 15 is a flowchart illustrating an example of the scan setting process by the client terminal 102 according to one or more aspects of the present disclosure.

In S1501, the client terminal 102 displays the scan settings screen as illustrated in FIG. 11 on the operation unit 308.

Next, in S1502, the client terminal 102 receives an operation from the user and advances the process to S1503.

In S1503, the client terminal 102 determines whether the user's operation received in S1502 is setting of scan settings.

If the user's operation is the setting of the scan settings (Yes in S1503), the client terminal 102 advances the process to S1504.

In S1504, the client terminal 102 updates the setting settings corresponding to the user's operation and returns the process to S1502.

On the other hand, if the user's operation is not the setting of the scan settings (No in S1503), the client terminal 102 ends the process in the flowchart of FIG. 15.

Next, a procedure for the transmission process by the client terminal 102 in S1306 will be described in detail with reference to FIG. 16.

FIG. 16 is a flowchart illustrating an example of the transmission process by the client terminal 102 according to one or more aspects of the present disclosure.

In S1601, the client terminal 102 transmits a scan job to the intermediate server 103 and registers the scan job in the intermediate server 103. The scan job includes the transmission destination settings set in S1304 illustrated in FIG. 13 and the scan settings set in S1305 illustrated in FIG. 13.

Subsequently, in S1602, the client terminal 102 acquires, from the intermediate server 103, the status of the scan job registered in S1601. In this case, the client terminal 102 may display the acquired status of the scan job on the operation unit 308.

Thereafter, in S1603, the client terminal 102 determines whether the status of the scan job acquired in S1602 is a complete status.

If the status of the scan job is not the complete status (No in S1603), the client terminal 102 returns the process to S1602.

On the other hand, if the status of the scan job is the complete status (Yes in S1603), the client terminal 102 advances the process to S1604.

In S1604, the client terminal 102 displays the push scanning completion screen as illustrated in FIG. 12 on the operation unit 308 and ends the process in the flowchart of FIG. 16.

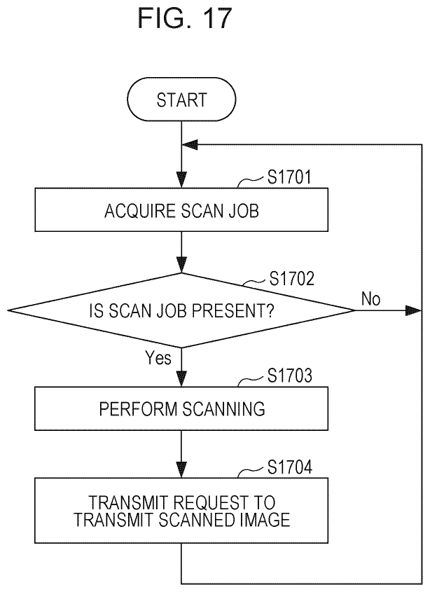

Next, a procedure by the MFP 101 according to one or more aspects of the present disclosure will be described with reference to FIG. 17.

FIG. 17 is a flowchart illustrating an example of a process by the MFP 101 according to one or more aspects of the present disclosure. The process by the MFP 101 in the flowchart of FIG. 17 is implemented by the CPU 201 of the MFP 101 reading and executing a program stored in the ROM 202 or the like.

In S1701, the MFP 101 acquires the scan job from the intermediate server 103. The scan job includes a scanner job ID and the scan settings. A step of acquiring the scan job in S1701 may be periodically performed or may be performed in accordance with a user's operation from the operation unit 204.

Next, in S1702, the MFP 101 confirms whether the scan job is present in a response from the intermediate server 103 in S1701.

If the scan job is not present (No in S1702), the MFP 101 returns the process to S1701.

On the other hand, if the scan job is present (Yes in S1702), the MFP 101 advances the process to S1703.

In S1703, the MFP 101 performs scanning with the scan settings included in the scan job acquired in S1701. The MFP 101 may display, on the operation unit 204, a list of one or more scan jobs acquired in S1701, receive user's selection of a scan job to be executed from the operation unit 204, and execute the scan job selected by the user in S1703. A scan job that is not executed in this case is stored in the HDD 208 of the MFP 101 after S1703, displayed in the list of the one or more scan jobs, and is executable by a user's operation. When the user instructs the MFP 101 to delete a scan job displayed in the list of the one or more scan jobs, the MFP 101 deletes the scan job instructed to be deleted, and transmits the scan ID of the deleted scan job to the intermediate server 103.

After the scanning is performed in S1703, the MFP 101 transmits, to the intermediate server 103, a request (request to transmit a scanned image) to transmit an image scanned in S1703. The request to transmit the scanned image includes the scan job ID acquired in S1701 and the image scanned in S1703. Thereafter, the MFP 101 returns the process to S1701.

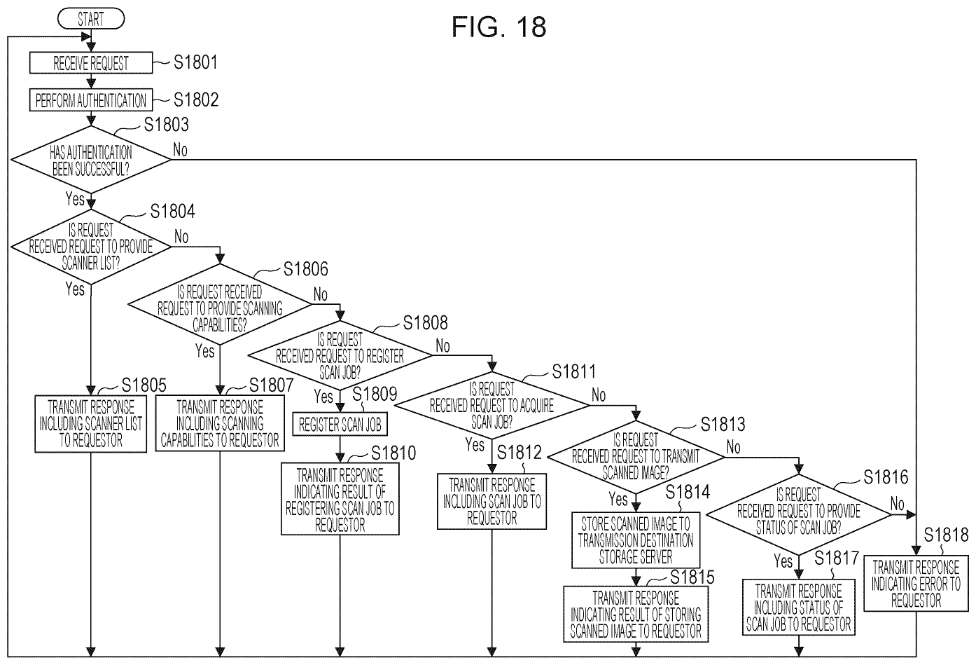

Next, a procedure by the intermediate server 103 according to one or more aspects of the present disclosure will be described with reference to FIG. 18.

FIG. 18 is a flowchart illustrating an example of a process by the intermediate server 103 according to one or more aspects of the present disclosure. The process by the intermediate server 103 in the flowchart of FIG. 18 is implemented by the CPU 401 of the intermediate server 103 reading an executing a program stored in the HDD 404 or the like.

In S1801, upon receiving a request from an external terminal, the intermediate server 103 advances the process to S1802. The request from the external terminal includes authentication information of a requestor.

In S1802, the intermediate server 103 performs authentication of the requestor using the authentication information included in the request received in S1801.

Next, in S1803, the intermediate server 103 determines whether the authentication has been successful in S1802.

If the authentication has failed (No in S1803), the intermediate server 103 advances the process to S1818.

In S1818, the intermediate server 103 transmits a response indicating an error to the requestor and returns the process to S1801.

On the other hand, if the authentication has been successful (Yes in S1803), the intermediate server 103 advances the process to S1804.

In S1804, the intermediate server 103 determines whether the request received in S1801 is a request to provide a scanner list.

If the request is the request to provide the scanner list (Yes in S1804), the intermediate server 103 advances the process to S1805.

In S1805, the intermediate server 103 transmits a response including the scanner list to the requestor and returns the process to S1801. In the transmission of the response, the intermediate server 103 transmits the scanner list registered as indicated by Table 1.

On the other hand, if the request is not the request to provide the scanner list (No in S1804), the intermediate server 103 advances the process to S1806.

In S1806, the intermediate server 103 determines whether the request received in S1801 is a request to provide scanning capabilities.

If the request is the request to provide the scanning capabilities (Yes in S1806), the intermediate server 103 advances the process to S1807. The request to provide the scanning capabilities includes a scanner ID.

In S1807, the intermediate server 103 transmits, to the requestor, a response including the scanning capabilities of a scanner corresponding to the scanner ID included in the request to provide the scanning capabilities, and returns the process to S1801.

On the other hand, if the request is not the request to provide the scanning capabilities (No in S1806), the intermediate server 103 advances the process to S1808.

In S1808, the intermediate server 103 determines whether the request received in S1801 is a request to register a scan job.

If the request is the request to register the scan job (Yes in S1808), the intermediate server 103 advances the process to S1809.

In S1809, the intermediate server 103 issues a scan job ID and associates the scanner ID identified based on the authentication information used in S1802, transmission destination settings and scan settings included in the request, and a job status, and registers the scan job ID, the scanner ID, the transmission destination settings, the scan settings, and the job status in the table as indicated by Table 2.

Thereafter, in S1810, the intermediate server 103 transmits, to the requestor, a response indicating a result of registering the scan job, and returns the process to S1801.

On the other hand, if the request is not the request to register the scan job (No in S1808), the intermediate server 103 advances the process to S1811.

In S1811, the intermediate server 103 determines whether the request received in S1801 is a request to acquire the scan job.

If the request is the request to acquire the scan job (Yes in S1811), the intermediate server 103 advances the process to S1812. The request to acquire the scan job includes the scanner ID.

In S1812, the intermediate server 103 transmits, to the requestor, a response including the scan job associated with the scanner ID included in the request based on the information as indicated by Table 2, and returns the process to S1801.

On the other hand, if the request is not the request to acquire the scan job (No in S1811), the intermediate server 103 advances the process to $1813.

In S1813, the intermediate server 103 determines whether the request received in S1801 is a request to transmit a scanned image. The request to transmit the scanned image includes the scanned image and the scan job ID.

If the request is the request to transmit the scanned image (Yes in S1813), the intermediate server 103 advances the process to S1814.

In S1814, the intermediate server 103 identifies the transmission destination settings from the scan job ID included in the request to transmit the scanned image, and stores, to a storage destination of a transmission destination storage server indicated by the transmission destination settings, the scanned image included in the request to transmit the scanned image (the intermediate server 103 transmits, to the transmission destination storage server 104, a request to store the scanned image, and the request to store the scanned image includes authentication information, storage destination information, and the scanned image).

Subsequently, in S1815, the intermediate server 103 transmits, to the requestor, a response indicating a result of storing the scanned image, and returns the process to S1801.

In the present embodiment, the request to transmit the scanned image includes the scanned image and the scan job ID, and the intermediate server 103 acquires the transmission destination settings from the scan job registered in the DB 406 using the scan job ID included in the request to transmit the scanned image, and transmits the scanned image. However, the request to transmit the scanned image may include the scanned image and settings for transmission of the scan job, and the intermediate server 103 may transmit the scanned image using the transmission destination settings included in the request to transmit the scanned image. In this configuration, a server that registers the scan job from the client terminal 102 and from which the MFP 101 acquires the scan job may not be the intermediate server 103.

On the other hand, if the request is not the request to transmit the scanned image (No in S1813), the intermediate server 103 advances the process to S1816.

In S1816, the intermediate server 103 determines whether the request received in S1801 is a request to acquire the status of the scan job.

If the request is the request to acquire the status of the scan job (Yes in S1816), the intermediate server 103 advances the process to S1817.

In S1817, the intermediate server 103 identifies the status of the scan job from the scan job ID included in the request based on the information as indicated by Table 2, transmits a response including the identified status to the requestor, and returns the process to S1801.

On the other hand, if the request is not the request to acquire the status of the scan job (No in S1816), the intermediate server 103 advances the process to S1818.

In S1818, the intermediate server 103 transmits a response indicating an error to the requestor and returns the process to S1801.

In this example, the requests processed by the intermediate server 103 are the request to provide the scanner list, the request to provide the scanning capabilities, the request to register the scan job, the request to acquire the scan job, the request to transmit the scanned image, and the request to acquire the status of the scan job, but another request may be processed by the intermediate server 103. In this case, it is assumed that the intermediate server 103 performs processing for the request and transmits a response to the request.

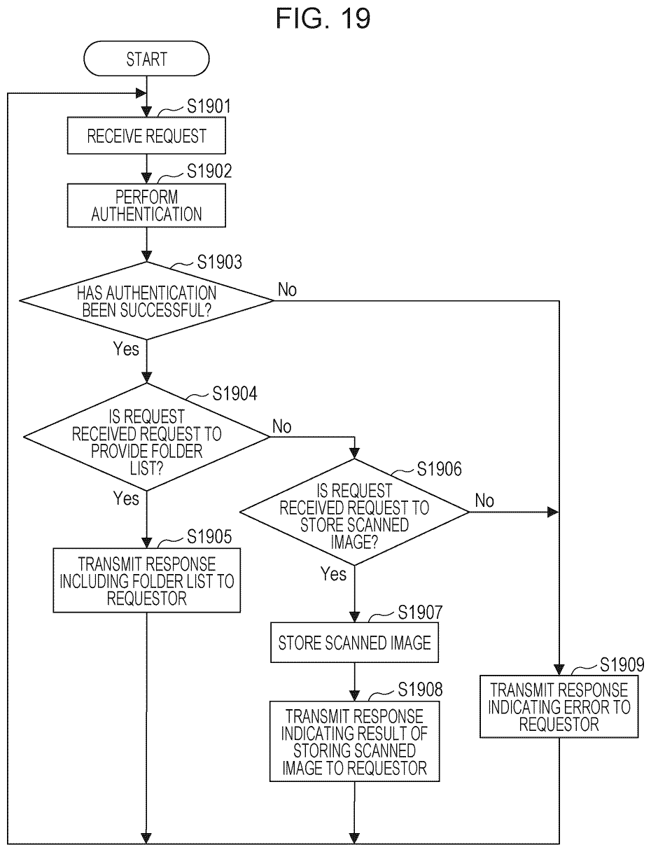

Next, a procedure by the storage server 104 according to one or more aspects of the present disclosure will be described with reference to FIG. 19.

FIG. 19 is a flowchart illustrating an example of a process by the storage server 104 according to one or more aspects of the present disclosure. The process by the storage server 104 in the flowchart of FIG. 19 is implemented by the CPU 501 of the storage server 104 reading and executing a program stored in the storage 504 or the like.

In S1901, the storage server 104 receives a request from an external terminal and advances the process to S1902.

In S1902, the storage server 104 performs authentication of a requestor based on the request received in S1901.

Thereafter, in S1903, the storage server 104 determines whether the authentication in S1902 has been successful.

If the authentication has failed (No in S1903), the storage server 104 advances the process to S1909.

In S1909, the storage server 104 transmits a response indicating an error to the requestor and returns the process to S1901.

If the authentication has been successful (Yes in S1903), the storage server 104 advances the process to S1904.

In S1904, the storage server 104 determines whether the request received in S1901 is a request to provide a folder list.

If the request is the request to provide the folder list (Yes in S1904), the storage server 104 advances the process to S1905.

In S1905, the storage server 104 acquires folder information from folder identification information included in the request to provide the folder list, transmits a response including the folder information to the requestor, and returns the process to S1901.

On the other hand, if the request is not the request to provide the folder list (No in S1904), the storage server 104 advances the process to S1906.

In S1906, the storage server 104 determines whether the request received in S1901 is a request to store a scanned image.

If the request is the request to store the scanned image (Yes in S1906), the storage server 104 advances the process to S1907. The request to store the scanned image includes storage destination information and the scanned image.

In S1907, the storage server 104 performs processing of storing the scanned image based on the storage destination information and the scanned image included in the request.

Thereafter, in S1908, the storage server 104 transmits, to the requestor, a response indicating a result of performing the processing of storing the scanned image, and returns the process to S1901.

On the other hand, if the request is not the request to store the scanned image (No in S1906), the storage server 104 advances the process to S1909.

In S1909, the storage server 104 transmits a response indicating an error to the requestor and returns the process to S1901.

In this example, the requests processed by the storage server 104 are the request to provide the folder list and the request to store the scanned image, but another request may be processed by the storage server 104. In this case, it is assumed that the intermediate server 103 performs processing for the request and transmits a response to the request.

In the present embodiment, it is assumed that the communication is performed via the intermediate server. However, data communication may be performed directly with another server such as a log collection server without the intermediate server.

According to the first embodiment, the image processing apparatus transmits a scanned image to the storage server via the intermediate server, the user can cause the image processing apparatus to perform push scanning by only operating an external terminal without operating a screen of the image processing apparatus, and thus it is possible to reduce the operational burden on the user. In this manner, it is possible to improve the usability of cloud scanning.

The client terminal 102 may be capable of transmitting a request to acquire a scan job to the intermediate server 103, acquiring the scan job registered in the intermediate server 103, and receiving a user's operation for modifying the scan job. When the scan job is modified, the client terminal 102 may transmit, to the intermediate server 103, an update request including the modified scan job, and the intermediate server 103 may modify the scan job registered in the intermediate server 103.

### Second Embodiment

A second embodiment describes a configuration in which the client terminal transmits, to the image processing apparatus, a request to transmit a scan job, and the image processing apparatus transmits a scanned image to a transmission destination cloud via the intermediate server.

In the first embodiment, the client terminal transmits, to the image processing apparatus via the intermediate server, a request to transmit a scan job. In the second embodiment, the client terminal directly transmits, to the image processing apparatus without the intermediate server, a request to transmit a scan job. This feature in the second embodiment is different from the first embodiment, and will be described below in detail.

An example of a configuration of a system in the second embodiment is the same as the configuration illustrated in FIG. 1 in the first embodiment, except that a role of each terminal is different from that in the first embodiment, for example, the MFP 101 receives a request to issue a scan job from the client terminal 102. Therefore, the configuration illustrated in FIG. 1 will be referred to and the example of the configuration in the second embodiment will not be described in detail.

The MFP 101 according to the second embodiment manages a scan job and receives, from the client terminal 102 via the network line 105, a request to register a scan job and another request. The MFP 101 also manages authentication information for restricting these requests.

Each of the configurations illustrated in FIGS. 2 to 5 in the second embodiment is the same as that in the first embodiment. Therefore, the configurations illustrated in FIGS. 2 to 5 will be referred to and the configurations in the second embodiment will not be described in detail.

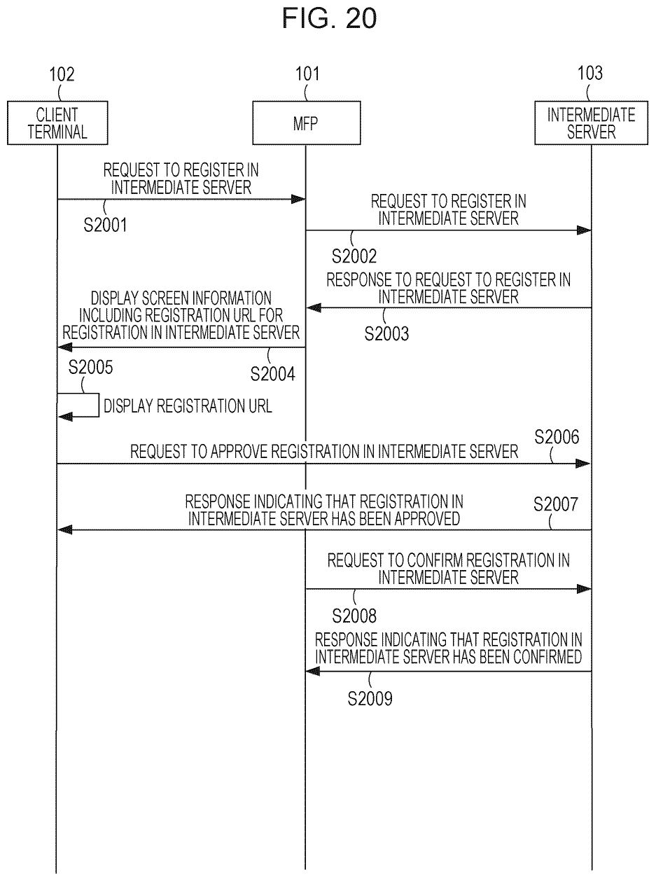

An example of a sequence for cooperation of the MFP 101 and the intermediate server 103 will be described below with reference to FIG. 20.

FIG. 20 is a diagram illustrating an example of a sequence for registration of the MFP 101 in the intermediate server 103 according to one or more aspects of the present disclosure. In FIG. 20, processing by the client terminal 102 is implemented by the CPU 301 of the client terminal 102 reading and executing a program stored in the flash ROM 306 or the like, processing by the MFP 101 is implemented by the CPU 201 of the MFP 101 reading and executing a program stored in the ROM 202 or the like, and processing by the intermediate server 103 is implemented by the CPU 401 of the intermediate server 103 reading and executing a program stored in the HDD 404 or the like.

First, a user uses the client terminal 102 to perform an operation for transmitting, to the MFP 101, a request to register the MFP 101 in the intermediate server 103. Upon receiving the operation, the client terminal 102 transmits, to the MFP 101, the request to register the MFP 101 in the intermediate server 103 (S2001).

Upon receiving the request in S2001, the MFP 101 transmits, to the intermediate server 103, the request to register the MFP 101 in the intermediate server 103 (S2002).

Upon receiving the request in S2002, the intermediate server 103 transmits, to the MFP 101, a response to the request to register the MFP 101 in the intermediate server 103 (S2003). The response includes a registration URL for registration in the intermediate server 103.

Upon receiving the response in S2003, the MFP 101 transmits, to the client terminal 102, display screen information including the registration URL for registration in the intermediate server 103 (S2004).

Upon receiving the display screen information in S2004, the client terminal 102 displays, on the operation unit 308, a screen (not illustrated) including the registration URL in accordance with the display screen information (S2005).

The user operates the client terminal 102 to access the registration URL displayed in S2005. In response to the access, the client terminal 102 transmits, to the intermediate server 103, a request to approve the registration in the intermediate server 103 (S2006).

The request to approve the registration in the intermediate server 103 includes a client ID and authentication information for the client ID. The client ID and the authentication information for the client ID indicate a user having the authority to use the intermediate server 103, and the user is registered in the intermediate server 103 in advance.

Upon receiving the request to approve the registration in S2006, the intermediate server 103 performs processing of registering the MFP 101 based on the request to approve the registration, and transmits, to the client terminal 102, a response indicating that the registration in the intermediate server 103 has been approved (S2007). The intermediate server 103 provides a scanner ID to the MFP 101 and registers the scanner ID in the DB 406 in the registration processing. The scanner ID is used to identify a scanner registered in the intermediate server 103.

The MFP 101 transmits, to the intermediate server 103, a request to confirm the registration in the intermediate server 103 (S2008).

Upon receiving the request to confirm the registration in S2008, the intermediate server 103 transmits, to the MFP 101, a response indicating that the registration in the intermediate server 103 has been confirmed (S2009). The response includes the scanner ID. Upon receiving the response in S2009, The MFP 101 holds the scanner ID included in the response in, for example, the HDD 208.

At this point of time, the MFP 101 becomes registered in the intermediate server 103 and becomes enabled to transmit a request to transmit a scanned image to the intermediate server 103.

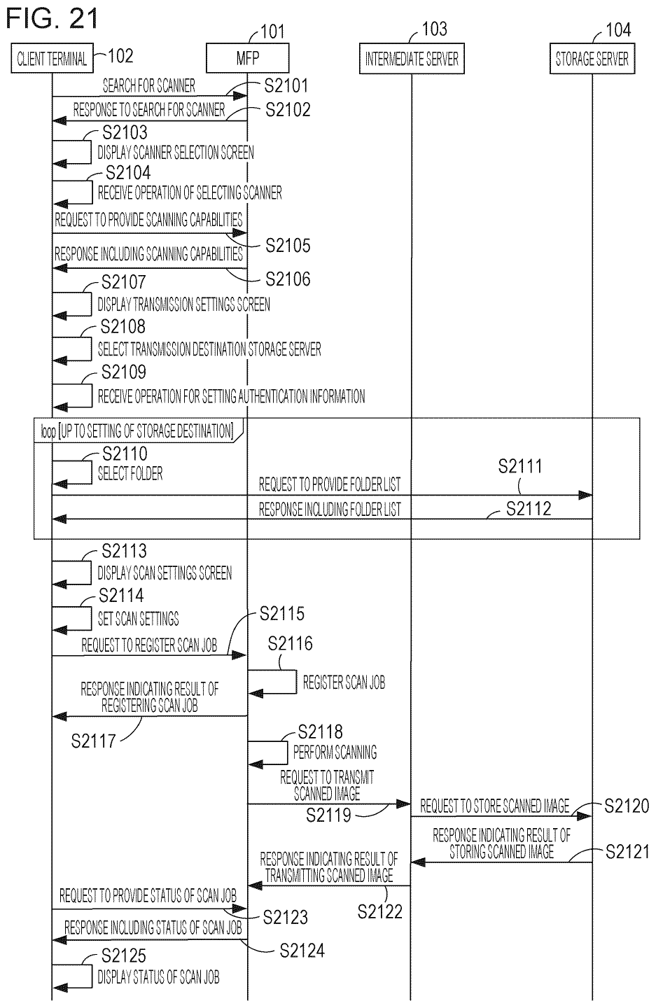

Next, an example of a sequence in which the client terminal 102 instructs the MFP 101 to transmit a scanned image to the storage server 104 via the intermediate server 103 will be described with reference to FIG. 21. It is assumed that each communication is authenticated in this sequence.

FIG. 21 is a diagram illustrating an example of a sequence for push scanning according to one or more aspects of the present disclosure. In FIG. 21, processing by the client terminal 102 is implemented by the CPU 301 of the client terminal 102 reading an executing a program stored in the flash ROM 306 or the like, processing by the MFP 101 is implemented by the CPU 201 of the MFP 101 reading and executing a program stored in the ROM 202 or the like, processing by the intermediate server 103 is implemented by the CPU 401 of the intermediate server 103 reading and executing a program stored in the HDD 404 or the like, and processing by the storage server 104 is implemented by the CPU 501 of the storage server 104 reading and executing a program stored in the storage 504 or the like.

First, the client terminal 102 searches for (detects) a scanner available for a communication terminal present on the same LAN on which the client terminal 102 is present (S2101).

The MFP 101 and another scanner transmit a response in response to S2101 (S2102).

Upon receiving the response in S2102, the client terminal 102 displays, on the operation unit 308, the scanner selection screen as illustrated in FIG. 8 based on the received response (S2103). A scanner displayed as a selection option on the scanner selection screen is the scanner that has transmitted the response in S2101.

When the user performs, on the scanner selection screen displayed in S2103, an operation of selecting a scanner to be used, the client terminal 102 receives the operation of selecting the scanner (S2104). In this case, it is assumed the MFP 101 has been selected.

The client terminal 102 transmits, to the MFP 101 selected in S2104, a request to provide information including the scanning capabilities (S2105).

Upon receiving the request in S2105, the MFP 101 transmits, to the client terminal 102, a response including the scanning capabilities (S2106).

Upon receiving the response in S2106, the client terminal 102 receives various settings (S2107 to S2114). The settings may not be received in the order indicated in the sequence illustrated in FIG. 21. The settings will be described below in detail.

First, transmission destination settings in S2107 to S2112 will be described.

The client terminal 102 displays, on the operation unit 308, the settings screen for transmission as illustrated in FIG. 9 (S2107).

When the user performs an operation of selecting a transmission destination storage server from the transmission settings screen as illustrated in FIG. 9 (when the user presses the “storage server” button 901 to select the storage server), the client terminal 102 receives the operation of selecting the transmission destination storage server (S2108). A sequence in a case that the storage server 104 is selected as a transmission destination in S2108 will be described below.

The client terminal 102 receives a user's operation for setting authentication information for the storage server 104 selected in S2108 (S2109). Specifically, when the “authentication information” button 902 is pressed, the client terminal 102 displays, on the operation unit 308, a settings screen (not illustrated) for the authentication information for the storage server 104 selected in S2108. When the user performs an operation of entering the authentication information from the settings screen, the client terminal 102 receives the operation. In a case where the authentication information has already been set by a previous operation or the like (in a case where “already set” is displayed on the “authentication information” button 902), S2109 may be omitted. In addition, the client terminal 102 may acquire, as the authentication information, an access token or the like for OAuth authentication by communicating with an authentication server. In this case, an operation for setting the authentication information received from the user includes an operation such as an operation of entering the user's name and a password into the authentication server or biometric authentication. The client terminal 102 may acquire the access token from the authentication server via the intermediate server 103. In the present embodiment, it is assumed that the authentication is performed using the access token as the authentication information, but another authentication method such as password authentication may be performed. In addition, the client terminal 102 may have a function of confirming whether the set authentication information is valid.

The client terminal 102 receives a user's operation for setting a storage destination in the storage server 104 selected in S2108 (S2110 to S2112).

Specifically, when the “storage destination” button 903 is pressed, the client terminal 102 displays, on the operation unit 308, the screen as illustrated in FIG. 10 as a settings screen for the storage destination in the storage server 104 selected in S2108. When the user performs an operation of selecting a folder from the folder structure 1002 on the screen as illustrated in FIG. 10, the client terminal 102 receives the operation of selecting the folder (S2110). The client terminal 102 transmits, to the storage server 104, a request to provide a list in the folder selected in S2110 (S2111). The request in S2111 includes identification information of the folder selected in S2110. The request to provide the list may be transmitted via the intermediate server 103. Upon receiving the request to provide the list in S2111, the storage server 104 transmits a response including the list in the folder according to the request to provide the list (S2112). Upon receiving the response in S2112, the client terminal 102 displays, on the operation unit 308, the settings screen for the storage destination based on the list included in the response and receives an operation of further selecting a folder or an operation of setting the storage destination.

Thereafter, when the user performs an operation for selecting a folder (when the folder is selected or the “up” button 1003 or the “back” button 1004 is pressed), the client terminal 102 returns the process to S2110. On the other hand, when the “set” button 1005 is pressed, the client terminal 102 determines that the selection of the folder as a storage destination has been set, and advances the process to S2113.

The client terminal 102 receives scan settings (S2113 and S2114). Specifically, the client terminal 102 displays the settings screen for scanning as illustrated in FIG. 11 on the operation unit 308 (S2113).

Various setting items and settable values displayed on the scan settings screen are based on the information including the scanning capabilities included in the response transmitted from the MFP 101 in S2106.

When the user performs an operation for setting the scan settings on the scan settings screen, the client terminal 102 receives the operation (S2114).

When the “start transmission” button 1108 is pressed on the scan settings screen so as to set the scan settings, each of the settings received in S2107 to S2114 is completed.

When each of the settings received in S2107 to S2114 is completed, the client terminal 102 transmits, to the MFP 101, a request to register a scan job (S2115). The request to register the scan job includes transmission destination settings including the authentication information set in S2108 to S2112, and the scan settings set in S2114.

Upon receiving the request to register the scan job in S2115, the MFP 101 issues a scan job ID according to the request to register the scan job and registers the scan job as indicated by Table 3 described later (S2116). The MFP 101 transmits, to the client terminal 102, a response indicating a result of registering the scan job (S2117). The response indicating the result of registering the scan job in S2117 includes the scan job ID. The client terminal 102 receives the response in S2117. In response to the reception of the response, the client terminal 102 outputs, to the operation unit 308, a display indicating that the scan job has been registered.

The MFP 101 extracts the scan settings from the registered scan job and performs scanning (S2118). It is assumed that a document to be scanned is placed on the MFP 101 before the scanning is performed. After the scan job is registered in S2116, the MFP 101 may display a list of one or more registered scan jobs on the operation unit 204 in accordance with a user's operation, receive, from the operation unit 204, user's selection of a scan job to be executed, and execute the selected scan job.

When the scanning in S2118 is ended, the MFP 101 transmits, to the intermediate server 103, a request to transmit a scanned image (S2119). The request to transmit the scanned image includes the image scanned in S2118 and the transmission destination settings included in the request from the client terminal 102 in S2115.

Upon receiving the request to transmit the scanned image in S2119, the intermediate server 103 transmits, to the storage server 104, a request to store the scanned image based on the transmission destination settings included in the request to transmit the scanned image (S2120). The request to store the scanned image in S2120 includes storage destination information and the authentication information such as an access token that are included in the transmission destination settings included in the request transmitted by the MFP 101 in S2119.

Upon receiving the request to store the scanned image in S2120, the storage server 104 stores the scanned image included in the request to store the scanned image and transmits, to the intermediate server 103, a response indicating a result of storing the scanned image (S2121).

Upon receiving the response indicating the result of storing the scanned image in S2121, the intermediate server 103 transmits, to the MFP 101, a response indicating a result of transmitting the scanned image (S2122).

The client terminal 102 transmits, to the MFP 101, a request to provide the status of the scan job (S2123). The request in S2123 includes the scan job ID included in the response transmitted from the intermediate server 103 in S2117. In S2123, the request is periodically transmitted until the status of the scan job changes to a complete status after the transmission of the response in S2117.

Upon receiving the request to provide the status of the scan job in S2123, the MFP 101 identifies the status of the scan job from the scan job ID included in the request in S2123 based on information as indicated by Table 3 described later and transmits a response including the status of the scan job to the client terminal 102 (S2124).

Upon receiving the response in S2124, the client terminal 102 displays the status of the scan job included in the response as illustrated in FIG. 12 (S2125).

The processing in S2118 and the subsequent processing may be performed immediately after the processing in S2117, or may be performed when the user operates the MFP 101 to instruct to perform the processing in S2118 and the subsequent processing.

Table 3 indicates an example of a table used by the MFP 101 to manage scan jobs.

TABLE 3

| Scan | Transmission destination | | Job |
|---|---|---|---|
| job ID | settings | Scan settings | status |
| 1 | server: example.cloud.com | source: platen | ready |
| | dest: ¥¥share¥folderA | size: a4 | |
| | token: abc123 | color: cl | |
| | | . . . | |
| 2 | server: example.cloud.com | source: platen | sending |
| | dest: ¥¥userA¥document | size: a3 | |
| | token: def456 | color: bw | |
| | | . . . | |
| 3 | server: sample.cloud.com | source: feerder | complete |
| | dest: ¥¥userB¥temp | size: letter | |
| | token: xyz789 | color: cl | |
| | | . . . | |

In each record of the table indicated by Table 3, a scan job ID identifying a scan job, transmission destination settings, scan settings, and a job status of the scan job are registered. Each column of the table will be described using, as an example, a record in which a scan job ID is “1” in Table 3. In the transmission destination settings, “server” indicates that a transmission destination storage server is “example.cloud.com”, “dest” indicates that a storage destination is “¥¥share¥folderA”, and “token” indicates that authentication information is “abc123”. In the scan settings, “source” indicates a reading source, “platen” indicates settings for reading from the pressing plate, “size” indicates the size of a sheet to be read, “a4” indicates that an A4 sheet is read, “color” indicates the color mode, and “cl” indicates that the sheet is read in color. It is assumed that other scan settings are described in a similar manner. Since the job status indicates “ready”, the job status indicates that the scan job is being prepared. A column indicating a client ID may be added to the table such that a scan job can be managed for each client terminal. In addition, a column based on a purpose of use may be present in the table.

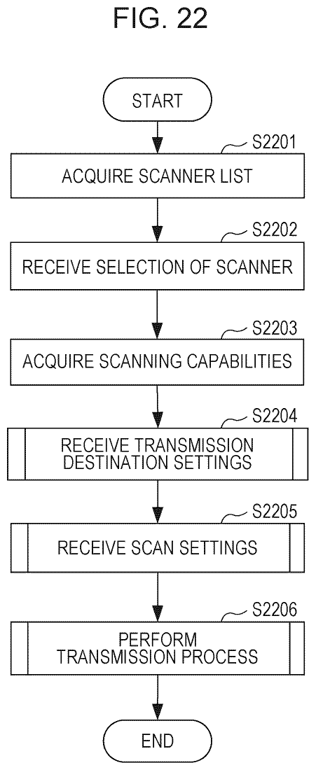

A procedure up to completion of transmission by the client terminal 102 according to one or more aspects of the present disclosure will be described with reference to FIG. 22.

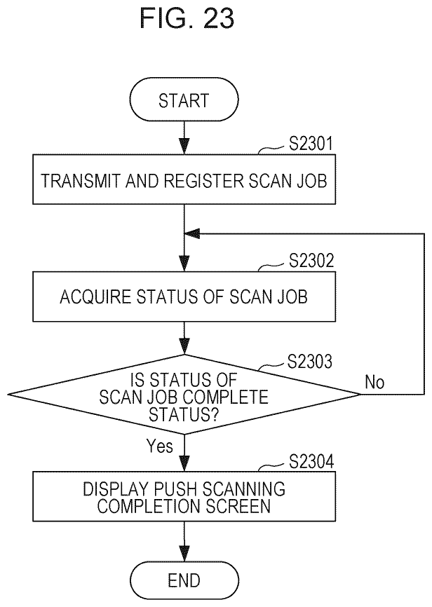

FIG. 22 is a flowchart illustrating an example of a process from the acquisition of a scanner list to the completion of the transmission of a scanned image by the client terminal 102 according to one or more aspects of the present disclosure. The process by the client terminal 102 in the flowchart of FIG. 22 and a flowchart of FIG. 23 (described later) are implemented by the CPU 301 of the client terminal 102 reading and executing a program stored in the flash ROM 306 or the like.

In S2201, the client terminal 102 searches for (detects) a scanner available for a communication terminal present on the same LAN on which the client terminal 102 is present, and acquires a list of the scanner.

Next, in S2202, the client terminal 102 displays, on the operation unit 308, the scanner selection screen as illustrated in FIG. 8 based on the scanner list acquired in S2101 and receives, from the user, selection of a scanner to be used. Upon receiving the selection of the scanner, the client terminal 102 advances the process to S2203.

In S2203, the client terminal 102 acquires, from the scanner selected in S2202, scanning capabilities of the scanner selected in S2202.

Next, in S2204, the client terminal 102 receives transmission destination settings from the user. Details of S2204 are the same as those described with reference to FIG. 14 and will not be described.

Next, in S2205, the client terminal 102 receives scan settings from the user. Details of S2205 are the same as those described with reference to FIG. 15 and will not be described.

Next, in S2206, the client terminal 102 performs a transmission process based on the settings received in S2204 and S2205. S2206 will be described later in detail with reference to FIG. 23.

After the transmission process, the client terminal 102 ends the process in the flowchart of FIG. 22.

Next, a procedure for the transmission process by the client terminal 102 in S2206 will be described with reference to FIG. 23.

FIG. 23 is a flowchart illustrating an example of the transmission process by the client terminal 102 according to one or more aspects of the present disclosure.

In S2301, the client terminal 102 transmits a scan job to the MFP 101 and registers the scan job in the MFP 101. The scan job includes the transmission destination settings set in S2204 illustrated in FIG. 22 and the scan settings set in S2205 illustrated in FIG. 22.

Subsequently, in S2302, the client terminal 102 acquires the status of the scan job registered in S2301 from the MFP 101. In this case, the client terminal 102 may display the acquired status of the scan job on the operation unit 308.

Thereafter, in S2303, the client terminal 102 determines whether the status of the scan job acquired in S2302 is a complete status.

If the status of the scan job is not the complete status (No in S2303), the client terminal 102 returns the process to S2302.

On the other hand, if the scan job is the complete status (Yes in S2303), the client terminal 102 advances the process to S2304.

In S2304, the client terminal 102 displays, on the operation unit 308, the push scanning completion screen as illustrated in FIG. 12 and ends the process in the flowchart of FIG. 23.

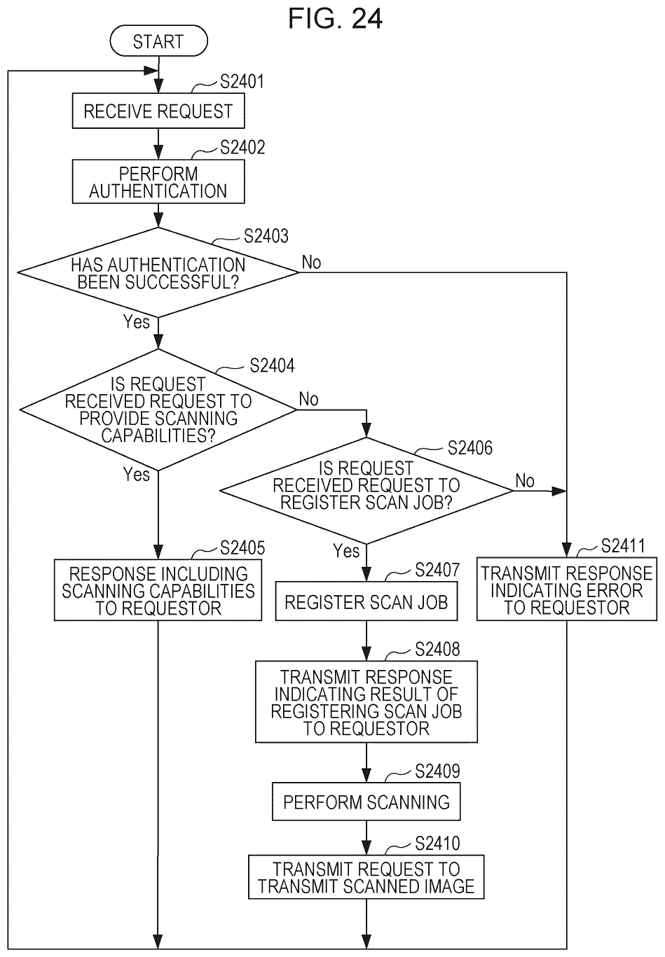

Next, a procedure by the MFP 101 according to one or more aspects of the present disclosure will be described with reference to FIG. 24.

FIG. 24 is a flowchart illustrating an example of a process by the MFP 101 according to one or more aspects of the present disclosure. The process by the MFP 101 in the flowchart of FIG. 24 is implemented by the CPU 201 of the MFP 101 reading and executing a program stored in the ROM 202 or the like.

In S2401, upon receiving a request from an external terminal, the MFP 101 advances the process to S2402. The request received in S2401 includes authentication information of a requestor.

In S2402, the MFP 101 performs authentication of the requestor using the authentication information included in the request received in S2401.

Next, in S2403, the MFP 101 determines whether the authentication in S2402 has been successful.

If the authentication has failed (No in S2403), the MFP 101 advances the process to S2411.

In S2411, the MFP 101 transmits a response indicating an error to the requestor and returns the process to S2401.

On the other hand, if the authentication has been successful (Yes in S2403), the MFP 101 advances the process to S2404.

In S2404, the MFP 101 determines whether the request received in S2401 is a request to provide the scanning capabilities.

If the request received in S2401 is the request to provide the scanning capabilities (Yes in S2404), the MFP 101 advances the process to S2405.

In S2405, the MFP 101 transmits a response including the scanning capabilities to the requestor and returns the process to S2401.

On the other hand, if the request received in S2401 is not the request to provide the scanning capabilities (No in S2404), the MFP 101 advances the process to S2406.

In S2406, the MFP 101 determines whether the request received in S2401 is a request to register a scan job.

If the request received in S2401 is not the request to register the scan job (No in S2406), the MFP 101 advances the process to S2411.

In S2411, the MFP 101 transmits a response indicating an error to the requestor and returns the process to S2401.

On the other hand, if the request received in S2401 is the request to register the scan job (Yes in S2406), the MFP 101 advances the process to S2407.

In S2407, the MFP 101 issues a scan job ID, associates the transmission destination settings and scan settings included in the request, and the status of the scan job, and registers the transmission destination settings, the scan settings, and the status of the scan job in the table as indicated by Table 3.

Next, in S2408, the MFP 101 transmits, to the requestor, a response indicating a result of registering the scan job.

Subsequently, in S2409, the MFP 101 performs scanning with the scan settings included in the registered scan job. The MFP 101 may display a list of one or more registered scan jobs on the operation unit 204, receive, from the operation unit 204, user's selection of a scan job to be executed, and execute the selected scan job.

After the scanning is performed in S2409, the MFP 101 transmits, to the intermediate server 103, a request to transmit a scanned image in S2410. The request to transmit the scanned image includes the image scanned in S2409 and settings for transmission of the scan job corresponding to the scanned image. Thereafter, the MFP 101 returns the process to S2401.

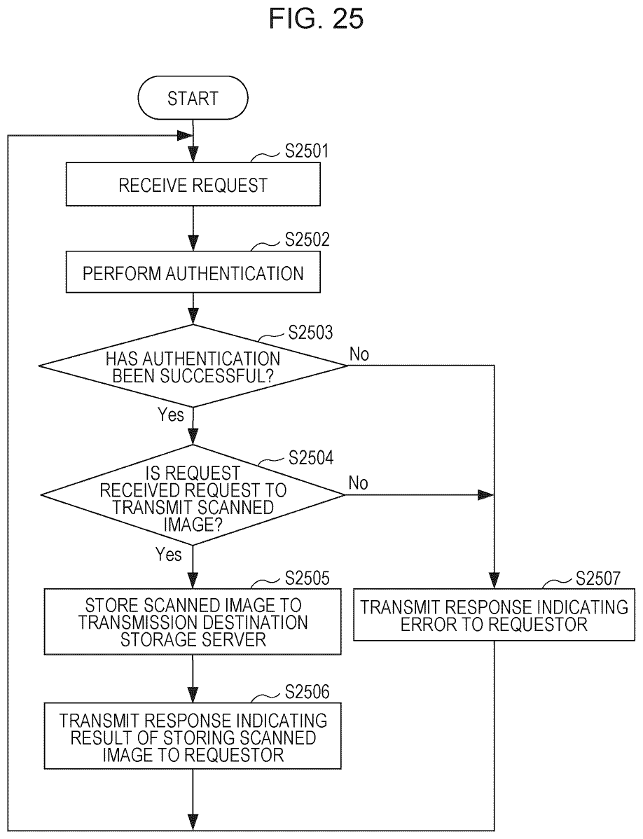

Next, a procedure by the intermediate server 103 according to one or more aspects of the present disclosure will be described with reference to FIG. 25.

FIG. 25 is a flowchart illustrating an example of a process by the intermediate server 103 according to one or more aspects of the present disclosure. The process by the intermediate server 103 in the flowchart of FIG. 25 is implemented by the CPU 401 of the intermediate server 103 reading and executing a program stored in the HDD 404 or the like.

In S2501, upon receiving a request from an external terminal, the intermediate server 103 advances the process to S2502. The request received in S2501 includes authentication information of a requestor.

In S2502, the intermediate server 103 performs authentication of the requestor using the authentication information included in the request received in S2501.

Next, in S2503, the intermediate server 103 determines whether the authentication in S2502 has been successful.

If the authentication has failed (No in S2503), the intermediate server 103 advances the process to S2507. In S2507, the intermediate server 103 transmits a response indicating an error to the requestor and returns the process to S2501.

On the other hand, if the authentication has been successful (Yes in S2503), the intermediate server 103 advances the process to S2504.

In S2504, the intermediate server 103 determines whether the request received in S2501 is a request to transmit a scanned image.

If the request received in S2501 is not the request to transmit the scanned image (No in S2504), the intermediate server 103 advances the process to S2507. In S2507, the intermediate server 103 transmits a response indicating an error to the requestor and returns the process to S2501.

If the request received in S2501 is the request to transmit the scanned image (Yes in S2504), the intermediate server 103 advances the process to S2505.

In S2505, the intermediate server 103 identifies a transmission destination storage server using transmission destination settings included in the request to transmit the scanned image, and stores, to a storage destination in the storage server, the scanned image included in the request to transmit the scanned image (the intermediate server 103 transmits, to the transmission destination storage server 104, a request to store the scanned image, and the request to store the scanned image includes the authentication information, storage destination information, and the scanned image).

Subsequently, in S2506, the intermediate server 103 transmits, to the requestor, a response indicating a result of storing the scanned image in S2505, and returns the process to S2401.

A procedure by the storage server 104 is the same as that illustrated in FIG. 19, and will not be described.

In the present embodiment, it is assumed that the communication is performed via the intermediate server. However, data communication may be performed with another server such as a log collection server without the intermediate server.

According to the second embodiment, the image processing apparatus transmits a scanned image to the storage server via the intermediate server, and the user can cause the image processing apparatus to perform push scanning by only operating an external terminal without operating a screen of the image processing apparatus.

There is an existing technique for registering a job in an intermediate server from an external terminal such as a PC, acquiring the job by an image processing apparatus from the intermediate server, performing scanning, and transmitting a scanned image to a transmission destination storage server (PCT Japanese Translation Patent Publication No. 2013-543339). In PCT Japanese Translation Patent Publication No. 2013-543339, a user can perform push scanning without operating a screen of the image processing apparatus. However, PCT Japanese Translation Patent Publication No. 2013-543339 discloses the technique in which the image processing apparatus is connected to the transmission destination storage server and transmits the scanned image. In a case where a plurality of storage servers that can serve as transmission destinations are present, the image processing apparatus needs to have, incorporated therein, an application program interface (API) or the like for connection to each of the storage servers in order to transmit the scanned image to each of the storage servers.

In a case where a scanned image can be transmitted to a plurality of storage servers via the intermediate server in push scanning, a connection process for transmission to each of the storage servers can be consolidated into the intermediate server. Therefore, the image processing apparatus does not need to have, incorporated therein, an API or the like for connection to each of the storage servers. However, in this case, in the existing technique, it is necessary to operate a screen of the image processing apparatus, and set settings necessary for push scanning, such as authentication information and storage destination information of the transmission destination storage server, and the operational burden on the user is great. On the other hand, in each of the embodiments of the present disclosure, the image processing apparatus such as the MFP 101 transmits a scanned image to the storage server via the intermediate server, the user can set settings (scan settings, transmission destination settings, and authentication information and storage destination information of the transmission destination storage server) necessary for push scanning by using an external terminal such as the client terminal 102, and it is possible to significantly reduce the operational burden in the push scanning. Therefore, it is possible to significantly improve the convenience of cloud scanning.

In each of the embodiments, it is possible to significantly improve the convenience of cloud scanning.

The configuration and contents of the above-described various data are not limited to those described above, and it goes without saying that the data is configured in various configurations and has various contents depending on the application and the purpose. In addition, configurations obtained by combining the embodiments are included in the present disclosure.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-180617, filed Oct. 16, 2024, which is hereby incorporated by reference herein in its entirety.

What is claimed is:

1. A service providing server that provides a print service and a scan service, the service providing server comprising:
one or more memories storing instructions; and
one or more processors which, when executing the instructions, causes the service providing server to:
register an image processing apparatus as a printing apparatus or a scanner apparatus based on a request to register the image processing apparatus from the image processing apparatus;
manage storage destination information of an external storage service that is a storage destination of scanned image data;
receive the scanned image data from the image processing apparatus registered as the scanner apparatus; and
transmit, to the external storage service, a request to store the scanned image data to the storage destination indicated by the storage destination information by using an access token for using the external storage service, the access token being acquired in accordance with user authentication on a client terminal for an authentication service.

2. The service providing server according to claim 1, wherein
the storage destination information is managed as a scan job.

3. The service providing server according to claim 2, wherein
a job status is managed for the scan job.

4. The service providing server according to claim 1, wherein
the access token is acquired from an authentication server accessed by the client terminal via the service providing server.

5. The service providing server according to claim 1, wherein
the service providing server receives information including scanning capabilities from the image processing apparatus registered as the scanner apparatus and manages the information including the scanning capabilities as information of the scanner apparatus.

6. The service providing server according to claim 1, wherein
the service providing server provides a list of the registered image processing apparatus to the client terminal.

7. The service providing server according to claim 1, wherein
the service providing server registers an image processing apparatus having a scan function and a print function as a printing apparatus and a scanner apparatus based on a request to register the image processing apparatus having the scan function and the print function from the image processing apparatus having the scan function and the print function.

8. The service providing server according to claim 1, wherein
the service providing server transmits a print job to the image processing apparatus registered as the printing apparatus.

9. A control method in a service providing server that provides a print service and a scan service, the control method comprising:
registering an image processing apparatus as a printing apparatus or a scanner apparatus based on a request to register the image processing apparatus from the image processing apparatus;
managing storage destination information of an external storage service that is a storage destination of scanned image data;
receiving the scanned image data from the image processing apparatus registered as the scanner apparatus; and
transmitting, to the external storage service, a request to store the scanned image data to the storage destination indicated by the storage destination information by using an access token for using the external storage service, the access token being acquired in accordance with user authentication on a client terminal for an authentication service.

10. A system including an image processing apparatus and a service providing server that provides a print service and a scan service,
the service providing server comprising:
one or more memories storing instructions; and
one or more processors which, when executing the instructions, causes the service providing server to:
register the image processing apparatus as a printing apparatus or a scanner apparatus based on a request to register the image processing apparatus from the image processing apparatus;
manage storage destination information of an external storage service that is a storage destination of scanned image data;
receive the scanned image data from the image processing apparatus registered as the scanner apparatus; and
transmit, to the external storage service, a request to store the scanned image data to the storage destination indicated by the storage destination information by using an access token for using the external storage service, the access token being acquired in accordance with user authentication on a client terminal for an authentication service.
